(19) United States
(12) Patent Application Publication
(10) Pub. No.: US 2012/0315365 A1
(43) Pub. Date: Dec. 13, 2012

(54) Omega-3 Fatty Acid Enriched Meat Compositions

(75) Inventors: Seok Lee, Edwardsville, IL (US); Candice Lucak, St. Louis, MO (US); Mac W. Orcutt, St. Louis, MO (US)

(73) Assignee: Solae, LLC, St. Louis, MO (US)

(21) Appl. No.: 13/510,434

(22) PCT Filed: Dec. 17, 2010
(86) PCT No.: PCT/US10/61088

§ 371 Date: May 17, 2012

Related U.S. Application Data
(60) Provisional application No. 61/287,477, filed on Dec. 17, 2009.

(51) Int. Cl. A23L 1/314; A23L 1/317; A23J 3/16

(52) U.S. Cl. 426/541; 426/641; 426/574; 426/646; 426/547

(57) ABSTRACT

The present invention relates to compositions and methods for producing a meat composition with a quantity of long chain fatty acids. Specifically, the meat composition comprises a quantity of stearidonic acid enriched soybean ingredient that imparts improved nutritional quality with a quantity of long chain fatty acids, but retains the mouthfeel, flavor, odor, and other sensory characteristics associated with typical meat compositions.

This application claims priority from U.S. Provisional Application Ser. No. 61/287,477 filed on Dec. 17, 2009, which is hereby incorporated by reference in its entirety.

### FIELD OF THE INVENTION

The present invention generally relates to meat compositions with a quantity of polyunsaturated fatty acids and the method of making such compositions. More specifically, the invention is to a meat composition that comprises a quantity of stearidonic acid (SDA) enriched soybean oil and the method of making the meat composition. The meat composition possesses improved nutritional qualities through the addition of the SDA enriched soybean oil, which comprises a quantity of omega-3 polyunsaturated fatty acids (n-3 PUFAs).

### BACKGROUND OF THE INVENTION

Recent dietary studies have suggested that certain types of fats are beneficial to body functions and improved health. The use of dietary fats is associated with a variety of therapeutic and preventative health benefits. Current research has demonstrated that the consumption of foods rich in n-3 PUFAs and especially omega-3 long chain polyunsaturated fatty acids (n-3 LCPUFAs), such as eicosapentaenoic acid (EPA; 20:5, n-3) and docosahexaenoic acid (DHA; 22:6, n-3) decreases cardiovascular death by positively impacting a number of markers, such as decreasing plasma triglycerides and blood pressure, and reducing platelet aggregation and inflammation. Typically, PUFAs, including n-3 LCPUFAs, are derived from plant or marine sources. Marine oils, found in fatty fish, are important dietary sources of the n-3 PUFAs, such as EPA and DHA. While fatty fish may be the best source of these n-3 PUFAs, many individuals do not like the taste of such seafood, do not have ready access to such seafood, or cannot afford such seafood. One solution is to supplement the diet with cod liver oil or fish oil capsules, but many people find the consumption of large capsules (ca. 1 g each) difficult, and so this solution has limited compliance. Another solution is to add n-3 PUFAs rich fish oils directly to foods, such as meat compositions.

A challenge with the latter approach is to provide the benefits of n-3 PUFAs without imparting any offending fish flavors or fish odors, which develop as a consequence of lipid oxidation. Currently, meat compositions may be found in the marketplace that include a quantity of n-3 PUFAs derived from flax (used either as full-fat flour or as oil, both providing α-linolenic acid (ALA; 18:3 n-3)), marine-based sources, (such as fish oil), or from land-based algal sources (produced by fermentation, typically DHA in this case).

These ingredients contribute a significant quantity of n-3 PUFAs, but these sources of n-3 PUFAs are typically unstable and are especially susceptible to rapid oxidation. Consequently, in current products containing n-3 PUFAs from these sources, the levels of inclusion are very low and generally insufficient to have the desired health impact found at higher dietary levels of use. The unstable n-3 PUFAs found in the marine or algal-derived sources produce highly undesirable fishy or painty off-flavors and odors following retorting, processing, storing, and reheating the meat compositions. Therefore, there is a need for meat compositions that include a physiologically significant quantity of n-3 PUFAs that may be included with meat compositions that are then prepared and processed under traditional conditions yet does not produce fishy or other unacceptable flavors or odors in the final products.

Additionally, it is possible to consume certain plant derived food products or supplements that contain n-3 PUFAs. These plant derived n-3 PUFAs consist of α-linolenic acid (ALA; 18:3, n-3). ALA is susceptible to oxidation, which results in painty off-odors. Moreover, the bioconversion of ALA n-3 PUFAs (specifically EPA) is relatively inefficient. Thus there is need for forms of n-3 PUFAs that provide the benefits of ready conversion to n-3 LCPUFAs, as well as good oxidative stability in foods. Additionally, there is a need for a process that includes a quantity of stable n-3 PUFAs that is readily metabolized to n-3 LCPUFAs and the resultant meat compositions. As previously stated, the plant derived n-3 PUFAs (ALA) are also susceptible to oxidization and can impart offensive painty odors and tastes when exposed to both extreme processing steps and processing environments. Therefore, there is a need for a process and resultant meat compositions that include a quantity of n-3 PUFAs, that are stable and do not impart fishy or painty odors or tastes due to oxidation of the n-3 PUFAs during the processing steps, while being transported or stored before consumption.

### SUMMARY OF THE INVENTION

The present invention is to a meat composition or processed meat composition that includes a quantity of SDA enriched soybean ingredient. The meat compositions are broadly defined as animal whole muscle products, processed animal meat products, simulated meat products, meat analogs, or other food products that include a quantity of animal meat or simulated meat (i.e., meat substitute). The SDA enriched soybean oil contains n-3 PUFAs that when incorporated into the meat composition provide a clean flavor, longer shelf-life stability, minimal oxidation, stability when exposed to extreme processing conditions or reheating by a consumer and enhanced nutritional qualities when compared to other sources of n-3 PUFAs. Further, the meat compositions with the SDA enriched soybean oil possess similar taste, mouthfeel, odor, flavor, and sensory properties when compared to products made from conventional oils, such as soybean oil or other oil or lipid ingredients, but with increased nutritional values. Thus, the meat compositions of the current invention have sensory characteristics comparable to the sensory characteristics of meat compositions that do not contain SDA enriched soybean oil.

Additionally, the meat composition may include at least one stabilizing agent such as a synthetic antioxidant, a natural antioxidant or lecithin. Other stabilizing agents, such as other phospholipids or other antioxidants, can be combined with the SDA enriched soybean oil for incorporation into the meat compositions. The incorporation of the at least one stabilizing agent produces meat compositions that possess similar taste, mouthfeel, odor, flavor, and sensory properties when compared to products made from conventional oils, such as soybean oil, but with increased nutritional values, and enhanced storage and shelf stability. Thus, the meat compositions of the current invention which contain at least one stabilizing agent, have sensory characteristics comparable to the sensory characteristics of meat compositions that do not contain SDA enriched soybean oil.

The present invention is also directed to a method of using SDA enriched soybean oil and at least one stabilizing agent to produce a meat composition that has enhanced nutritional qualities but similar taste, mouthfeel, odor, flavor, and sensory properties when compared to a typical meat composition.

The current invention demonstrates processes, compositions, end products, and methods of using a SDA enriched soybean oil for meat compositions that possess certain nutritional and beneficial qualities for a consumer and have enhanced storage and shelf stability. Such meat compositions also have similar taste, mouthfeel, odor, and flavor as found in typical meat compositions desired by consumers.

### DESCRIPTION OF THE FIGURES

FIG. 1 graphically illustrates the sensory profiling of hotdog flavor differences at time zero (0) based on soybean oil and SDA oil. The black dashed line marks the Recognition Threshold Level of the average consumer.

FIG. 2 graphically illustrates the sensory profiling of hotdog texture differences at time zero (0) based on soybean oil and SDA oil.

FIG. 3 graphically illustrates the sensory profiling of hotdog flavor differences at twelve (12) weeks based on soybean oil and SDA oil. The black dashed line marks the Recognition Threshold Level of the average consumer.

FIG. 4 graphically illustrates the sensory profiling of hotdog texture differences at twelve (12) weeks based on soybean oil and SDA oil.

FIG. 5 graphically illustrates the sensory profiling of pepperoni flavor and aftertaste differences based on soybean oil and SDA oil. The black dashed line marks the Recognition Threshold Level of the average consumer.

FIG. 6 graphically illustrates the sensory profiling of pork sausage flavor and aftertaste differences based on soybean oil and SDA oil. The black dashed line marks the Recognition Threshold Level of the average consumer.

FIG. 7 graphically illustrates the sensory profiling of cooked ham flavor and aftertaste differences based on soybean oil and SDA oil. The black dashed line marks the Recognition Threshold Level of the average consumer.

### DETAILED DESCRIPTION OF THE INVENTION

The present invention relates to a method of using SDA enriched soybean oil, a process for producing meat compositions, and the resultant meat compositions that have increased nutritional values for consumption by consumers to improve their health. Further, the invention is to meat compositions with increased nutritional values that include a quantity of n-3 PUFAs but retain the mouthfeel, flavor, odor, and other characteristics of typical meat compositions that consumers desire.

Use of PUFAs and especially n-3 PUFAs in meat compositions is typically limited by the lack of oxidative stability. Because of the processing conditions used for producing some meat compositions (elevated processing temperatures, retort processing, extrusion processing, cooking, smoking, exposure to pro-oxidants (some metal ions)), and reconstitution by a consumer before consumption cause n-3 PUFAs to readily oxidize and produce off-flavors in the finished meat compositions. By using a type of n-3 PUFAs that is oxidatively stable during mixing, processing, packaging, during storage, transport, shelf life, and through cooking (reheating) by the consumer, a meat composition is produced that not only retains the mouthfeel, flavor, odor, and other characteristics of typical meat compositions but also have an increased nutritional value.

### (I) Compositions

One aspect of the present invention is a meat composition that comprises a quantity of n-3 PUFAs. The n-3 PUFAs are incorporated into the meat compositions through the use of SDA enriched soybean oil. In one embodiment the ingredient is a SDA enriched soybean oil that is obtained from soybeans that are engineered to produce high levels of stearidonic acid (SDA), such as those described in WO2008/085840 and WO2008/085841 and incorporated herein by reference. The soybeans can be processed according to the extraction method consistent with those methods described in US Patent Application 2006/0111578 and 2006/0111254 and incorporated herein by reference. In another embodiment, oil obtained from other plant sources with elevated SDA, such as but not limited to Echium spp and blackcurrant oil can be used.

In another embodiment the meat composition may further include a phospholipid to stabilize the oxidizable material and thus reduce its oxidation. A phospholipid comprises a backbone, a negatively charged phosphate group attached to an alcohol, and at least one fatty acid. Phospholipids having a glycerol backbone comprise two fatty acids and are termed glycerophospholipids. Examples of a glycerophospholipid include phosphatidylcholine, phosphatidylethanolamine, phosphatidylinositol, phosphatidylserine, and diphosphatidyiglycerol (i.e., cardiolipin). Phospholipids having a sphingosine backbone are called sphingomyelins. The fatty acids attached via ester bonds to the backbone of a phospholipid tend to be 12 to 22 carbons in length, and some may be unsaturated. For example, phospholipids may contain oleic acid (18:1), linolenic acid (18:2, an omega-6), and alpha-linolenic acid (18:3, an omega-3). The two fatty acids of a phospholipid may be the same or they may be different; e.g., dipalmitoylphosphatidylcholine, 1-stearyoyl-2-myristoylphosphatidylcholine, or 1-palmitoyl-2-linoleoylethanolamine.

In one embodiment, the phospholipid may be a single purified phospholipid, such as distearoylphosphatidylcholine. In another embodiment, the phospholipid may be a mixture of purified phospholipids, such as a mix of phosphatidylcholines. In still another embodiment, the phospholipid may be a mixture of different types of purified phospholipids, such as a mix of phosphatidylcholines and phosphatidylinositols or a mixture of phosphatidylcholines and phosphatidylethanolamines.

In an alternate embodiment, the phospholipid may be a complex mix of phospholipids, such as a lecithin. Lecithin is found in nearly every living organism. Commercial sources of lecithin include soybeans, rice, sunflower seeds, chicken egg yolks, milk fat, bovine brain, bovine heart, and algae. In its crude form, lecithin is a complex mixture of phospholipids, glycolipids, triglycerides, sterols and small quantities of fatty acids, carbohydrates and sphingolipids. Soy lecithin is rich in phosphatidylcholine, phosphatidylethanolamine, phosphatidylinositol, and phosphatidic acid. Lecithin may be de-oiled and treated such that it is an essentially pure mixture of phospholipids. Lecithin may be modified to make the phospholipids more water-soluble. Modifications include hydroxylation, acetylation, and enzyme treatment, in which one of the fatty acids is removed by a phospholipase enzyme and replaced with a hydroxyl group. In another embodiment the lecithin could be produced as a byproduct of the oil production from the SDA enriched soybeans, thus producing a product with a portion of the lecithin to be used with the SDA enriched soybean oil.

In yet another alternative embodiment, the phospholipid may be a soy lecithin produced under the trade name SOLEC® by Solae, LLC (St. Louis, Mo.). The soy lecithin may be SOLEC® F, a dry, de-oiled, non-enzyme modified preparation containing about 97% phospholipids. The soy lecithin may be SOLEC® 8160, a dry, de-oiled, enzyme-modified preparation containing about 97% phospholipids. The soy lecithin may be SOLEC® 8120, a dry, de-oiled, hydroxylated preparation containing about 97% phospholipids. The soy lecithin may be SOLEC® 8140, a dry, de-oiled, heat resistant preparation containing about 97% phospholipids. The soy lecithin may be SOLEC® R, a dry, de-oiled preparation in granular form containing about 97% phospholipids.

The ratio of the phospholipid to the SDA enriched soybean oil will vary depending upon the nature of the SDA enriched soybean oil and the phospholipid preparation. In particular, the concentration of phospholipid will be of a sufficient amount to prevent the oxidation of the SDA enriched soybean oil. The concentration of the phospholipid will generally range from less than 0.01% to about 65% by weight of the SDA enriched soybean oil. In one embodiment, the concentration of the phospholipid may range from about 2% to about 50% by weight of the SDA enriched soybean oil. In another embodiment, the concentration of the phospholipid may range from about 2% to about 10% by weight of the SDA enriched soybean oil. In an alternate embodiment, the concentration of the phospholipid may range from about 10% to about 20% by weight of the SDA enriched soybean oil. In yet another embodiment, the concentration of the phospholipid may range from about 20% to about 30% by weight of the oxidizable material. In still another embodiment, the concentration of the phospholipid may range from about 30% to about 40% by weight of the SDA enriched soybean oil. In another alternate embodiment, the concentration of the phospholipid may range from about 40% to about 50% by weight of the SDA enriched soybean oil. In another embodiment, the concentration of the phospholipid may range from about 15% to about 35% by weight of the SDA enriched soybean oil. In another embodiment, concentration of the phospholipid may range from about 25% to about 30% by weight of the SDA enriched soybean oil.

The meat compositions may comprise at least one additional antioxidant that is not a phospholipid or a lecithin. The additional antioxidant may further stabilize the SDA enriched soybean oil. The antioxidant may be natural or synthetic. Suitable antioxidants include, but are not limited to, ascorbic acid and its salts, ascorbyl palmitate, ascorbyl stearate, anoxomer, N-acetylcysteine, benzyl isothiocyanate, o-, m- or p-amino benzoic acid (o is anthranilic acid, p is PABA), butylated hydroxyanisole (BHA), butylated hydroxytoluene (BHT), caffeic acid, canthaxantin, alpha-carotene, beta-carotene, beta-apo-carotenoic acid, carnosol, carvacrol, cetyl gallate, chlorogenic acid, citric acid and its salts, clove extract, coffee bean extract, p-coumaric acid, 3,4-dihydroxybenzoic acid, N,N′-diphenyl-p-phenylenediamine (DPPD), dilauryl thiodipropionate, distearyl thiodipropionate, 2,6-di-tert-butylphenol, dodecyl gallate, edetic acid, ellagic acid, erythorbic acid, sodium erythorbate, esculetin, esculin, 6-ethoxy-1,2-dihydro-2,2,4-trimethylquinoline, ethyl gallate, ethyl maltol, ethylenediaminetetraacetic acid (EDTA), eucalyptus extract, eugenol, ferulic acid, flavonoids (e.g., catechin, epicatechin, epicatechin gallate, epigallocatechin (EGC), epigallocatechin gallate (EGCG), polyphenol epigallocatechin-3-gallate), flavones (e.g., apigenin, chrysin, luteolin), flavonols (e.g., datiscetin, myricetin, daemfero), flavanones, fraxetin, fumaric acid, gallic acid, gentian extract, gluconic acid, glycine, gum guaiacum, hesperetin, alpha-hydroxybenzyl phosphinic acid, hydroxycinammic acid, hydroxyglutaric acid, hydroquinone, N-hydroxysuccinic acid, hydroxytryrosol, hydroxyurea, lactic acid and its salts, lecithin, lecithin citrate; R-alpha-lipoic acid, lutein, lycopene, malic acid, maltol, 5-methoxy tryptamine, methyl gallate, monoglyceride citrate; monoisopropyl citrate; morin, beta-naphthoflavone, nordihydroguaiaretic acid (NDGA), octyl gallate, oxalic acid, palmityl citrate, phenothiazine, phosphatidylcholine, phosphoric acid, phosphates, phytic acid, phytylubichromel, pimento extract, propyl gallate, polyphosphates, quercetin, trans-resveratrol, rice bran extract, rosemary extract, rosmarinic acid, sage extract, sesamol, silymarin, sinapic acid, succinic acid, stearyl citrate, syringic acid, tartaric acid, thymol, tocopherols (i.e., alpha-, beta-, gamma- and delta-tocopherol), tocotrienols (i.e., alpha-, beta-, gamma- and delta-tocotrienols), tyrosol, vanilic acid, 2,6-di-tert-butyl-4-hydroxymethylphenol (i.e., lonox 100), 2,4-(tris-3′,5′-bi-tert-butyl-4′-hydroxybenzyl)-mesitylene (i.e., lonox 330), 2,4,5-trihydroxybutyrophenone, ubiquinone, tertiary butyl hydroquinone (TBHQ), thiodipropionic acid, trihydroxy butyrophenone, tryptamine, tyramine, uric acid, vitamin K and derivates, vitamin Q10, wheat germ oil, zeaxanthin, or combinations thereof. Preferred antioxidants include tocopherols, ascorbyl palmitate, ascorbic acid, and rosemary extract. The concentration of the additional antioxidant or combination of antioxidants may range from about 0.001% to about 5% by weight, and preferably from about 0.01% to about 1% by weight.

### (II) Method of Using and Processes for Forming the Compositions

Production of the n-3 PUFAs enriched meat compositions is accomplished by replacing a quantity of the soybean oil used as an ingredient with SDA enriched soybean oil for the meat compositions. In another embodiment, SDA enriched soybean oil can either replace part of or all of the existing fat or oil in an application or can be added additionally to those products that are naturally, or formulated to be low in fat. In one embodiment, the SDA enriched soybean oil will replace all the fat or oil used to produce the desired meat product. In an alternative embodiment, the SDA enriched soybean oil will replace a quantity of the fat or oil used in recipes to produce the meat composition, in order to produce an end product that contains a sufficient amount of n-3 PUFAs as recommended by the industry. The general consensus in the omega-3 research community is for a consumer to consume around 400-500 mg/day of EPA/DHA equivalent. (Harris et al. 2009 J. Nutr. 139:804 S-819S). Typically a consumer will consume four (4) 100 mg servings per day to ultimately consume 400 mg/day.

The meat compositions are generally formed dependent on the desired end product. The meat compositions are produced according to standard industry recipes and processing techniques except the oil ingredient or animal fat typically used is partially or totally replaced with the SDA enriched soybean oil. In another embodiment meat compositions are produced according to standard industry recipes and practices except an additional amount of the SDA enriched soybean oil is added to the recipe. The amount of SDA enriched soybean oil used will vary from about 1% to about 100% and is dependent on the end product and the nutritional value or amount of n-3 PUFAs desired in the end product. In one embodiment about 5% of the fat or oil used in a typical meat composition is replaced with the SDA enriched soybean oil. In another embodiment about 10% of the fat or oil used in a typical meat composition product is replaced with the SDA enriched soybean oil. In another embodiment about 25% of the fat or oil used in a typical meat composition is replaced with the SDA enriched soybean oil. In another embodiment about 50% of the fat or oil used in a typical meat composition is replaced with the SDA enriched soybean oil. In another embodiment about 75% of the fat or oil used in a typical meat composition is replaced with the SDA enriched soybean oil. In another embodiment about 90% of the fat or oil used in a typical meat composition is replaced with the SDA enriched soybean oil. In another embodiment about 95% of the fat or oil used in a typical meat composition is replaced with the SDA enriched soybean oil. In another embodiment about 100% of the fat or oil used in a typical meat composition is replaced with the SDA enriched soybean oil.

In another embodiment a quantity of at least one stabilizing agent, such as an antioxidant, is added to the meat composition. In one embodiment, the antioxidant is a lecithin and is combined with the SDA enriched soybean oil, the concentration of the lecithin in the meat composition is from less than about 0.01% to about 65% by weight of the SDA enriched soybean oil, and more typically, from about 15% to about 35% by weight of the SDA enriched soybean oil. In another embodiment, the concentration of the lecithin in the meat composition is from about 25% to about 30% by weight of the SDA enriched soybean oil. In another embodiment a quantity of SDA enriched soybean oil can be added in addition to the fat or oil typically used in the meat composition.

After including a quantity of the SDA enriched soybean oil and the at least one antioxidant, the meat mixture is then processed according to typical industry recipes. To produce the meat compositions, no additional processing or ingredients other than those typically used to produce the desired meat compositions are required; although at least one stabilizing agent may be included.

### (III) Food Products

A further aspect of the present invention is meat compositions with n-3 PUFAs incorporated and increased nutritional values; moreover, these compositions retain the mouthfeel, flavor, odor, and other characteristics of typical meat compositions. The SDA enriched meat compositions or SDA enriched simulated meat compositions can be processed into a variety of food products having a variety of shapes. The meat compositions will vary depending on the desired end product. The processing steps and end products will be similar to current meat compositions and simulated meat compositions on the market, except a quantity of SDA enriched soybean oil will be included with the meat composition or simulated meat compositions to form the desired end product of an SDA enriched meat composition or SDA enriched simulated meat composition.

Animal Meat

In one embodiment the meat composition of the invention includes a quantity of an animal meat product. The animal meat product can be reprocessed meat, typically pieces of processed meat products leftover during the manufacture of processed meat products, or whole intact animal meat. The processed meat composition of the invention optionally may further comprise cooked or uncooked animal meat in the formulation.

In one embodiment the meat composition can include reprocessed animal meat products such as pieces of processed meat products that were leftover during the manufacture of the processed meat products. The processed meat product may be broken, misshapen, have a split casing, be unevenly smoked, be an unusable end piece, and so forth. Non-limiting examples of suitable processed animal meat products that may be included in the composition of the invention include hot dogs, sausages, kielbasa, chorizo, bologna; luncheon meat products, canned ground meat products, and canned emulsified meat products. The processed animal meat product may comprise meat from cattle, swine, lamb, goats, wild game, poultry, fowl, fish, and/or seafood, as detailed below. Unless sealed under sterile conditions or frozen, the processed meat product will generally be stored at a temperature of about 4° C. or less.

In another embodiment the processed meat composition can include cooked or uncooked animal meat in the formulation. The animal meat used is preferably any meat useful for forming meat products. The animal meat may be useful for filling a permeable or impermeable casing and/or may be useful in ground meat applications, such as hamburgers, meat loaf, and minced meat products. The animal meat may be any cured or dry cured meat product, such as pork ham, poultry ham, pork bacon, poultry bacon, corned beef, cured pork, pastrami, salami, pepperoni, smoked meats, such as brisket, steaks, chops, or any other whole muscle cut of meat.

The animal meat may be mammalian meat such as from a farm animal selected from the group consisting of sheep, cattle, goats, pork, and horses. The animal meat may be from poultry or fowl, such as chicken, duck, goose or turkey. Alternatively, the animal meat may be from a game animal. Non-limiting examples of suitable game animals include buffalo, deer, elk, moose, reindeer, caribou, antelope, rabbit, squirrel, beaver, muskrat, opossum, raccoon, armadillo, porcupine, and snake. In a further embodiment, the animal meat may be from fish or seafood. Non-limiting examples of suitable fish include bass, carp, catfish, cobia, cod, grouper, flounder, haddock, hoki, perch, pollock, salmon, snapper, sole, trout, tuna, whitefish, and whiting. Non-limiting examples of seafood include shrimp, lobsters, clams, crabs, mussels, and oysters.

By way of example, meat includes striated muscle, which is skeletal muscle and partially defatted low-temperature fatty tissues, heart muscle, or smooth muscle that is found, for example, in the tongue or esophagus, with or without accompanying overlying fat and portions of the skin, sinew, nerve and blood vessels which normally accompany the meat flesh. Examples of meat by-products are organs and tissues such as lungs, spleens, kidneys, brain, liver, blood, bone, stomachs, intestines free of their contents, and the like. Poultry by-products include non-rendered, clean parts of carcasses, such as heads, feet, and viscera, free from fecal content and foreign matter.

It is also envisioned that a variety of meat forms may be utilized in the invention depending upon the product's intended use. For example, whole meat muscle that is either ground or in chunk or steak form may be utilized. In an additional embodiment, whole muscle meat pieces may be used that are unaltered or are intact pieces of meat. In a further embodiment, mechanically deboned meat (MDM) may be utilized. In the context of the present invention, MDM is any mechanically deboned meat including a meat paste that is recovered from a variety of animal bones, such as, beef, pork and chicken bones, using commercially available equipment. MDM is generally an untexturized comminuted product that is devoid of the natural fibrous texture found in intact muscles. In other embodiments, a combination of MDM and whole meat muscle may be utilized.

It is well known in the art to produce mechanically deboned or separated raw meats using high-pressure machinery that separates bone from animal tissue, by first crushing bone and adhering animal tissue and then forcing the animal tissue, and not the bone, through a sieve or similar screening device. The animal tissue in the present invention may comprise muscle tissue, organ tissue, connective tissue, and skin. The process forms an untexturized, paste-like blend of soft animal tissue with a batter-like consistency and is commonly referred to as MDM. This paste-like blend has a particle size of from about 0.25 to about 1.0 millimeters. In another embodiment, the particle size is up to about 3 millimeters. In a further embodiment, the particle size is up to about 5 millimeters.

Although the animal tissue, also known as raw meat, is preferably provided in at least substantially frozen form so as to avoid microbial spoilage prior to processing, once the meat is ground, it is not necessary to freeze it to provide cutability into individual strips or pieces. Unlike meat meal, raw meat has a natural moisture content of above about 60% and the protein is not denatured.

The animal meat cooked or raw (uncooked) used in the present invention may be any edible meat suitable for human consumption. The meat may be non-rendered, non-dried, raw meat, raw meat products, raw meat by-products, and mixtures thereof. The animal meat or meat products including the comminuted meat products are generally supplied daily in a completely frozen or at least substantially frozen condition so as to avoid microbial spoilage. In one embodiment, the temperature of the animal meat is below about −40° C. In another embodiment, the temperature of the meat is below about −20° C. In yet another embodiment, the temperature of the'meat is from about −4° C. to about 6° C. In a further embodiment, the temperature of the meat is from about −2° C. to about 2° C. While refrigerated or chilled meat may be used, it is generally impractical to store large quantities of unfrozen meat for extended periods of time at a plant site. The frozen products provide a longer lay time than do the refrigerated or chilled products. Non-limiting examples of animal meat products which may be used in the process of the present invention include pork shoulder, beef shoulder, beef flank, turkey thigh, beef liver, ox heart, pork heart, pork heads, pork diaphragm meat, beef mechanically deboned meat, pork mechanically deboned meat, and chicken mechanically deboned meat.

In lieu of frozen animal meat, the animal meat may be freshly prepared for the preparation of the processed meat product, as long as the freshly prepared animal meat is stored at a temperature that does not exceed about 4° C.

In another embodiment, the meat ingredient can be a simulated meat composition that may include a quantity of animal meat or may be animal meat free (i.e. vegetarian product). The simulated meat composition can be prepared according to typical industry recipes and processing techniques, with the SDA enriched ingredient replacing the oil or other lipid in a recipe, or the SDA enriched ingredient being added to the simulated meat product as an additional ingredient to form a SDA enriched simulated meat product.

The meat compositions will vary depending on the desired end product but can include any meat product known in the industry including but not limited to processed meats, for example frankfurters, wieners, meat loaves, smoked and cooked sausages, bologna, liverwurst, polish sausage, lunch meats, canned meats, minced or emulsified meats, coarse-ground meats, such as sausages, breakfast links, meat patties, pâtés, sticks, nuggets, cutlets, semidry or dry sausages, such as summer sausage, salami, pepperoni, chorizo, mortadella, whole muscle products, such as smoked hams, sliced/slab bacon, steaks, barbeque products such as ribs, brisket, pulled pork, dry cured pork, dried beef, canned meats, such as corned beef, beef stew, Vienna sausages, meat balls, or any other product that includes a meat product as an ingredient.

In another embodiment it is also envisioned that the processed meat compositions of the present invention may be utilized in a variety of animal diets. In one embodiment, the meat composition may be a composition formulated for companion animal consumption. In another embodiment the meat composition may be formulated for agricultural or zoo animal consumption. The formulations will be readily known to a person skilled in the art for the formulation for use in composition animal, agricultural animal or zoo animal diets.

One aspect of the present invention is processed meat compositions with n-3 PUFAs incorporated producing a product with increased nutritional values, but retains the mouthfeel, flavor, odor, and other characteristics of typical processed meats. Ingredients for preparing processed meats can include, with no limitations, pork, beef, veal, mutton, variety meats, and poultry. The processed meat compositions will vary depending on the desired end product but can include fresh ground meats, finely comminuted meats, fermented, and whole muscle meats including but not limited to raw meats, smoked meats, dried meats or cured meats. Non-limiting include, without limitation, the following ready-to-eat or raw processed meats; fresh sausages, smoked or unsmoked, such as bratwurst, brockwurst, breakfast sausages, kielbasa, mettwurst, polish, chervelat, chorizo; dry and semi-dry sausages, cured or uncured, such as genoa salami, pepperoni; cooked sausages such as frankfurters, braunschweiger, summer sausage, knockwurst and bologna; canned processed meats such as canned ham, chili con came, corned beef hash, luncheon meats and meat balls; chopped or ground meats, ground beef, ground chicken, ground veal, ground mutton, ground pork; emulsified meats such as bologna, frankfurters, liver sausage, loaves, luncheon meats; jellied meats such as blood, headcheese, scrapple, souse, and tongue, meat cuts, such as corned beef, Canadian-style bacon, pastrami, smoked poultry, ham; and restructured meats such as dried beef and boneless ham.

### DEFINITIONS

To facilitate understanding of the invention several terms are defined below.

The term “n-3 PUFAs” refers to omega-3 polyunsaturated fatty acids and includes omega-3 long chain polyunsaturated fatty acids and n-3 LCPUFAs.

The terms “stearidonic acid enriched soybean oil”, “SDA enriched soybean oil”, and “SDA oil” refer to soybean oil that has been enriched with stearidonic acid.

The term “meat” refers not only to the flesh of cattle, swine, sheep and goats, but also horses, whales and other mammals, poultry and fish. The term “meat by-products” is intended to refer to those non-rendered parts of the carcass of slaughtered animals including but not restricted to mammals, poultry and the like and including such constituents as are embraced by the term “meat by-products” in the Definitions of Feed Ingredients published by the Association of American Feed Control Officials, Incorporated. The terms “meat,” and “meat by-products,” are understood to apply to all of those animals, poultry and marine products defined by association.

The term “processed meat” refers to any meat food comprised of more than one ingredient. This meat could be raw, cooked, cured, uncured, fermented or dried.

The term “reconstituted meat” refers to a pre-cooked frozen meat product that requires heating prior to consumption.

The term “meat analog” refers to vegetarian products. Such products include vegan meat-like foods or meat-like foods that containing egg or dairy proteins used as processing.

The term “simulated meat” refers to vegetarian or meat foods that mimic specific forms of meat foods. As examples, finely ground meat combined with a textured or structured vegetable protein to form a meat food that mimics a cooked intact chicken breast or pork chop and wheat gluten, isolated soy protein and textured soy protein can be prepared in such as to produce a meat-like food that resembles a chicken breast or pork chop.

### EXAMPLES

The following examples are used herein to illustrate different aspects of this invention and are not meant to limit the present invention in any way. It should be appreciated by those of skill in the art that the techniques disclosed in the examples that follow represent techniques discovered by the inventors to function well in the practice of the invention. However, those of skill in the art should, in light of the present disclosure, appreciate that many changes can be made in the specific embodiments that are disclosed and still obtain a like or similar result without departing from the spirit and scope of the invention, therefore all matter set forth or shown in the application is to be interpreted as illustrative and not in a limiting sense.

### Example 1

### Hotdog Formulation

The following examples relate to a method of forming hotdogs that delivers a quantity of SDA per serving.

The lean meat from Table 1 below, was pre-ground using a Butcher Boy® Model A52 HF (American Meat Equipment, LLC, Selmer, Tenn.) to ¼″ (6 mm) grinder plate and then the fat meats were ground through a ¼″ (6 mm) grinder plate.

TABLE 1
Formulation for Hotdog

| | Control | SDA | Flax | Algal | Fish |
|---|---|---|---|---|---|
| Ingredients | % | % | % | % | % |
| Pork trim 80/20 | 23.00 | 23.00 | 23.00 | 23.00 | 23.00 |
| Pork trim 50/50 | 19.00 | 19.00 | 19.00 | 19.00 | 19.00 |
| Water/ice | 20.49 | 20.49 | 20.31 | 20.49 | 20.49 |
| Beef trim 80/20 | 24.79 | 24.79 | 24.79 | 24.79 | 24.79 |
| Corn syrup solids 42% | 2.00 | 2.00 | 2.00 | 2.00 | 2.00 |
| DE | | | | | |
| Salt | 1.80 | 1.80 | 1.80 | 1.80 | 1.80 |
| SUPRO ® EX 33 | 2.00 | 2.00 | 2.00 | 2.00 | 2.00 |
| Dextrose | 1.00 | 1.00 | 1.00 | 1.00 | 1.00 |
| Spices | 2.00 | 2.00 | 2.00 | 2.00 | 2.00 |
| Sodium tripolyphosphate | 0.30 | 0.30 | 0.30 | 0.30 | 0.30 |
| Cure salt | 0.17 | 0.17 | 0.17 | 0.17 | 0.17 |
| Erythorbate | 0.04 | 0.04 | 0.04 | 0.04 | 0.04 |
| Soybean oil (SBO) | 3.41 | 0.00 | 0.00 | 2.89 | 2.70 |
| SDA enriched soybean | 0.00 | 3.41 | 0.00 | 0.000 | 0.000 |
| oil | | | | | |
| Flaxseed oil | 0.00 | 0.00 | 3.59 | 0.000 | 0.000 |
| Algal oil | 0.00 | 0.00 | 0.000 | 0.52 | 0.000 |
| Fish oil | 0.00 | 0.00 | 0.000 | 0.000 | 0.71 |
| TOTAL | 100.00 | 100.00 | 100.00 | 100.00 | 100.00 |

The lean meat and sodium tripolyphosphate were chopped, using a Kramer Grebe Type Chopper (Model VSM 65, Biedenkopf, Germany) for 30 seconds, forming a meat batter.

Salt and cure salt were added to the meat batter, and the meat batter was chopped for 3 to 4 minutes at maximum knife speed. The temperature of the meat batter was controlled to less than 13° C. by adding ice water (⅔ ice and ⅓ water) as required.

SUPRO® EX33, isolated soy protein, was then added to the meat batter in the chopper, while continuing to control the temperature of the meat batter to less than 13° C. by adding ice water (⅔ ice and ⅓ water) as required. The meat batter was chopped for an additional 1 to 2 minutes at high speed.

The pork trims, beef trim, and oil were then added to the meat batter and chopped for an additional 1 minute, after which all the remaining ingredients and the rest of the ice water were added, and chopped for 30-45 seconds to the desired end point temperature of 13° C.

After chopping the meat batter was filled into casings (cellulose casing #28). The casings were filled using the Handtmann VF 200 filler (Handtmann, Buffalo Grove, Ill.), to achieve a target uncooked weight of 60 g per link and a cooked weight of 55 g.

The hotdogs were smoked (Alkar Thermal Processing Unit, Alkar-RapidPax, Inc., Lodi, Wis.) and cooked utilizing the thermal processing schedule outlined in Table 2.

The result was a hotdog that delivered a quantity of SDA per serving size while retaining the taste, structure, aroma, and mouthfeel of typical hotdogs currently on the market.

TABLE 2
Smoking and cooking times and temperatures for the hotdogs

| | | Cook | Dry Bulb | Wet Bulb | Cooking Chamber | | |
|---|---|---|---|---|---|---|---|
| | | Time | Temperature | Temperature | Relative | Main Blower | |
| Cook Step | Cook Type | (min) | (° C.) | (° C.) | Humidity (%) | Setting | Exhaust |
| 1 | Shower | | | | | | |
| 2 | Cook | 15 | 57.2 | 33.9 | 25 | 10 | Open |
| 3 | Smoke | 8 | 51.7 | 32.2 | 26 | 2 | Closed |
| 4 | Cook | 15 | 60.0 | 40.6 | 30 | 10 | Open |
| 5 | Cook | 15 | 71.1 | 50.6 | 35 | 10 | Open |
| 6 | Cook | 15 | 82.2 | 62.2 | 40 | 10 | Open |
| 7 | Cook | 1 | 85 | 66.7 | 45 | 10 | Open |
| 8 | Cold shower | 10-20 | — | — | — | — | — |

### Example 2

### Sensory Profiling of Hotdogs

Sensory descriptive analysis was conducted on hotdogs over a twelve-week shelf life testing at time zero (0) and twelve (12) weeks (stored at 5° C.) to understand the attribute differences of soybean oil and SDA oil in hotdogs. At time zero (0) there were seven (7) panelists and at twelve (12) weeks there were eight (8) panelists; all the panelists were trained in the Sensory Spectrum™ Descriptive Profiling method. The panelists evaluated the samples for 21 flavor attributes and 19 texture attributes. The attributes were evaluated on a 15-point scale, with 0=none/not applicable and 15=very strong/high in each sample. Definitions of the flavor attributes are given in Table 3 and definitions of the texture attributes are given in Table 4.

The hotdogs were prepared by boiling water in a pan, adding the hotdogs to the pan, covering the pan with a lid and removing the pan from heat and letting the pan sit for 4 minutes. The ends were cut off the hotdogs and the hotdogs were cut into 2.54 cm (1 inch) pieces. Each panelist received 5 pieces of hotdog in a 3 ounce cup with lid. The samples were presented monadically in duplicate.

The data were analyzed using the Analysis of Variance (ANOVA) to test product and replication effects. When the ANOVA result was significant, multiple comparisons of means were performed using the Tukey's HSD t-test. All differences were significant at a 95% confidence level unless otherwise noted. For flavor attributes, mean values<1.0 indicate that not all panelists perceived the attribute in the sample. A value of 2.0 was considered recognition threshold for all flavor attributes, which was the minimum level that the panelist could detect and still identify the attribute.

TABLE 3
Hot Dog Flavor Lexicon

| Attribute | Definition | Reference | |
|---|---|---|---|
| AROMATICS | | Intensities based on Universal Scale: | |
| | | Baking Soda in Saltine | 2.5 |
| | | Cooked Apple in | 5.0 |
| | | Applesauce | |
| | | Orange in Orange Juice | 7.5 |
| | | Concord Grape in Grape Juice | 10.0 |
| | | Cinnamon in Big Red Gum | 12.0 |

| Overall Flavor | The overall intensity of the product aromas, an | | |
|---|---|---|---|
| Impact | amalgamation of all perceived aromatics, basic tastes | | |
| | and chemical feeling factors. | | |
| Meat Complex | The general category used to describe the total meat | | |
| | flavor impact of the product | | |
| Pork | The gamey, cardboardy aromatic associated with | Pork trimmed of visible fat. | |
| | cooked/cured lean pork | Boiled ground pork | |
| Fat | Aromatic reminiscent of dairy lipid products, melted | Melted butter, Crisco, boiled. | |
| | vegetable shortening cooked chicken skin, and beef | chicken skins, beef tallow. | |
| | tallow | | |
| Poultry | Aromatics associated with White/dark meat turkey | Boiled white/dark meat turkey | |
| Beef | The animal/blood/marrow aromatic associated with lean | Cooked (boiled) lean ground | |
| | red meat | beef | |
| SWA | The general category of aromatics associated with sweet | Vanilla, molasses, honey, etc., | |
| | foods (confectionary) | corn syrup | |
| Spice Complex | The general category used to describe the total spice | | |
| | flavor impact of the product | | |
| Onion/Garlic | The aromatics associated with dehydrated onion and | Onion and garlic powder | |
| | garlic powders | solutions or Garlic oil capsules | |
| White/Black | The aromatic associated with white and black pepper | White pepper and black | |
| Pepper | | pepper solutions | |
| Smoke | The aromatic associated with any type of smoke flavor. | Wright's liquid smoke | |
| Paprika | The aromatic associated With paprika | Paprika solution | |
| TVP | The woody, vegetative aromatic associated with cooked | Hydrated TVP | |
| | texturized vegetable protein | | |
| Fishy/Pondy | The aroma/aromatics associated with triethylamine, | | |
| Complex | pond water or aged fish. The general term used to | | |
| | describe fish meat, which cannot be tied to a specific | | |
| | fish by name. | | |
| Fishy | Aromatic associated with trimethylamine and old fish. | Cod liver oil capsules, | |
| | | trimethylamine, Geisha | |
| | | canned lump crab | |
| Pondy | The aromas and aromatics associated with water | Algal oil (Martek 30% DHA | |
| | containing algae, reminiscent of pond water and aquatic | oil) | |
| | tanks. | | |
| BASIC TASTES | | | |
| | | Sucrose solution: | |
| Sweet | The taste on the tongue stimulated by sucrose | 2% | 2.0 |
| | and other sugars, such as fructose, glucose, | 5% | 5.0 |
| | etc., and by other sweet substances, such as | 10% | 10.0 |
| | saccharin, Aspartame, and Acesulfam-K. | 16% | 15.0 |
| | | Citric acid solution: | |
| Sour | The taste on the tongue stimulated by acid, | 0.05% | 2.0 |
| | such as citric, malic, phosphoric, etc. | 0.08% | 5.0 |
| | | 0.15% | 10.0 |
| | | 0.20% | 15.0 |
| | | Sodium chloride solution: | |
| Salt | The taste on the tongue associated with | 0.2% | 2.0 |
| | sodium salts. | 0.35% | 5.0 |
| | | 0.5% | 8.5 |
| | | 0.57% | 10.0 |
| | | 0.7% | 16.0 |
| | | Caffeine solution: | |
| Bitter | The taste on the tongue associated with | 0.05% | 2.0 |
| | caffeine and other bitter substances, such as | 0.08% | 5.0 |
| | quinine and hop bitters. | 0.15% | 10.0 |
| | | 0.20% | 15.0 |
| | | MSG solution: | |
| Umami | The taste on the tongue associated with | 6% | 5.0 |
| | monosodium glutamate. Savory. | | |

| | | |
|---|---|---|
| Chemical FF | | |
| Astringent | The shrinking or puckering of the tongue | Alum solution |
| | surface caused by substances such as tannins | |
| | or alum. | |
| Metallic | A flat chemical feeling factor stimulated on | Ferrous sulfate |
| | the tongue by metal coins | |
| Burn | Chemical feeling factor associated with high | Heinz white vinegar |
| | concentrations of irritants to the mucous | |
| | membranes of the oral cavity | |

TABLE 4

| | | |
|---|---|---|
| Attribute | Definition | Reference Scale |

Reduced Fat Hot Dog (Omega 3) Texture Lexicon

| | | |
|---|---|---|
| (i) SURFACE | | |
| Oily Lips | The amount of residual oil remaining on the | 0.0 Saltine Cracker-Unsalted |
| | lips after surface evaluation. | 5.0 Club Cracker |
| | Not at all - - - Extremely | 10.0 Popcorn |
| | | 15.0 Crisco on lips |
| Sticky Lips | The degree to which lips are left sticky after | 1.0 Starburst Candy |
| | surface evaluation. | 6.0 Dried Apricot |
| | Not at all - - - Extremely | 15.0 Marshmallow Fluff |
| PARTIAL COMPRESSION | | |
| Springiness | The amount to Which the sample returns to | 0.0 Starburst Candy |
| | its original shape. | 5.0 Pound Cake |
| | Dead - - - Springy | 9.0 Mini Marshmallow |
| | | 15.0 Gummi Bear |
| FIRST BITE | | |
| Hardness | The force to attain a given deformation; the force to | 1.0 Cream Cheese |
| | compress between molars. | 4.5 American Cheese |
| | Soft - - - Hard | 6.0 Goya Stuffed Olives |
| | | 7.0 Frankfurter |
| | | 9.5 Peanuts |
| | | 11.0 Carrots/Almonds |
| | | 14.5 Hard Candy |
| Cohesiveness | The amount to which the sample deforms rather than | 1.0 Corn Muffin |
| | crumbles, cracks or breaks. | 5.0 American Cheese |
| | Breaks/Crumbles - - - Deforms | 8.0 Soft Pretzel |
| | | 11.0-12.0 Candy Chews |
| | | 13.0 Caramel |
| | | 15.0 Chewing Gum |
| Denseness | The compactness of the sample cross-section. | 0.5 Whipped Topping |
| | Airy - - - Dense | 2.5 Marshmallow Topping |
| | | 2.5 Rice Krispies |
| | | 4.0 Club Crackers |
| | | 6.0 Malted Milk Balls |
| | | 9.0 Frankfurter |
| | | 15.0 Fruit Jelly Candy |
| Uniformity of Bite | The evenness of the force throughout the first bite. | 2.0 Chocolate Chip Ice |
| | Non-uniform - - - Uniform | Cream |
| | Multi-layered - - - Even | 4.0 Double Stuffed Oreo |
| | Uneven/Choppy - - - Even | 6.0 Regular Oreo |
| | | 8.5 Vienna Fingers |
| | | 10.5 Malted Milk Balls |
| | | 15.0 Caramel |

Reduced Fat Hot Dog (Omega 3) Lexicon

| | | |
|---|---|---|
| CHEWDOWN | | |
| # of Chews to | To bolus - The number of chews required to compress all | |
| Swallow/Bolus | the sample and form a bolus. | |
| | To swallow - The number of chews required to | |
| | form a bolus that can be swallowed (stop @ 15 max) | |
| Moisture Release | The amount of juice/moisture perceived in the mouth. | 1.0 Banana |
| | Dry (none) - - - Juicy (a lot) | 2.0 Carrot |
| | | 4.0 Mushroom |
| | | 7.0 Snap Bean |
| | | 9.0 Apple |
| | | 15.0 Orange |
| Moistness of Mass | The amount of wetness/oiliness on the surface of the | 3.0 Pork Rinds |
| | mass. | 6.5 Graham Crackers |
| | Dry - - - Wet/Oily | 13.0 Jell-O Jigglers |
| Cohesiveness of | The amount the chewed sample holds together in a mass. | 0.0 Shoestring Licorice |
| Mass | Loose mass - - - Tight mass | 2.0 Carrots |
| | | 4.0 Mushrooms |
| | | 7.5 Frankfurters |
| | | 10.0 American Cheese |
| | | 14.0 Fig Newton |
| Roughness of Mass | The amount of roughness on the surface of the mass. | 3.0 American Cheese |
| | Smooth - - - Rough | 5.0 Graham Crackers |
| | | 7.5 Melba Toast |
| | | 10.0 Triscut Cracker |
| | | 12.0 Carrots |
| | | 15.0 Granola Bar |
| Moisture | The amount of saliva absorbed by the sample during | 0.0 Shoestring Licorice |
| Absorption | chew down. | 3.5 Red Licorice Sticks |
| | No absorption - - - Large amount of absorption | 7.5 Popcorn |
| | | 10.0 Potato Chips |
| | | 13.0 Pound Cake |
| | | 15.0 Saltine Crackers |
| Rubberiness | The degree to which the texture is rubbery. | 0.0 Yellow American Cheese |
| | Not rubbery - - - Very Rubbery | 3.0 Boiled Chicken breast |
| | | 7.5 Gummi bears |
| | | 20.0 Rubber bands |
| Fibrous between | The amount of grinding of fibers to get through the | 2.5 Apricots |
| Teeth | sample. | 3.5-4.0 Apple |
| | Not Fibrous - - - Very Fibrous | 4.5-5.0 Salami |
| | | 9.0 Celery |
| | | 10.0 Toasted Oats |
| | | 12.0 Bacon |
| | | 20.0 Beef Jerky |
| RESIDUAL | | |
| Toothpack | The amount of product packed in the crevices (molars) of | 0.0 Mini clams |
| | the teeth after mastication of the product. | 1.0 Fresh carrots |
| | None - - - A lot | 3.0 Mushrooms |
| | | 7.5 Graham Crackers |
| | | 9.0 American Cheese |
| | | 11.0 Cheese Doodles/puffs |
| | | 15.0 Jujubees |
| Toothstick | The amount of product adhering on the sides of the teeth | 1.0-2.0 Club Cracker |
| | after mastication of the product. | 15.0 Starburst Candy |
| | None - - - A lot | |
| Loose Particles | The amount of particles remaining in the oral cavity after | 0.0 Miracle Whip |
| | expectoration/consumption of the sample. | 0.0 Silk |
| | None - - - A lot | 5.0 Sour cream + cream of |
| | | wheat |
| | | 10.0 Mayo + corn flour |
| Oily Mouthcoating | The amount of coating/film remaining in the mouth after | 1.0 Silk (Chalky, Tacky) |
| | expectoration. | 3.0 Cooked corn starch |
| | None - - - A lot | 8.0 Pureed potato |
| | | 12.0 Tooth powder |

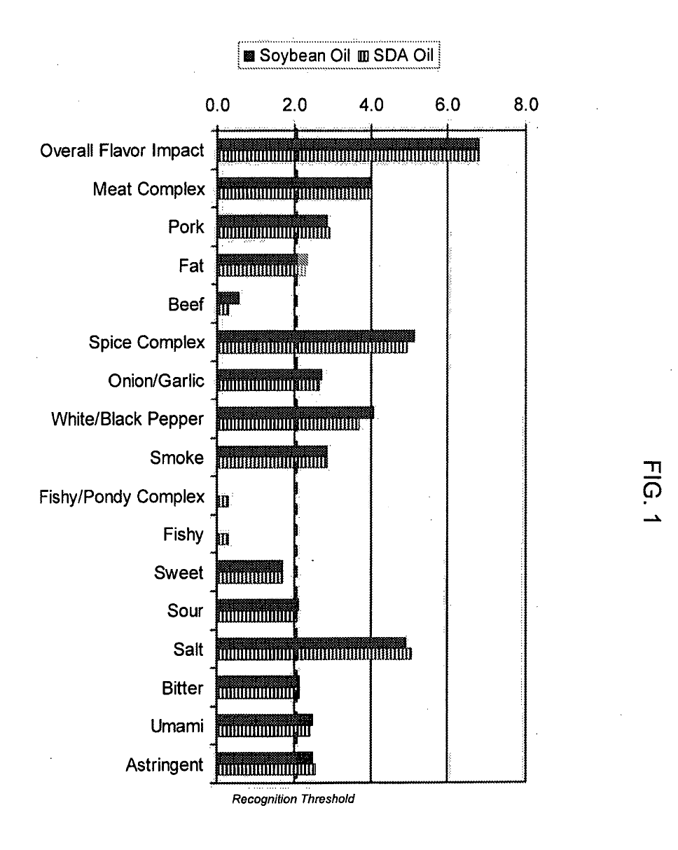

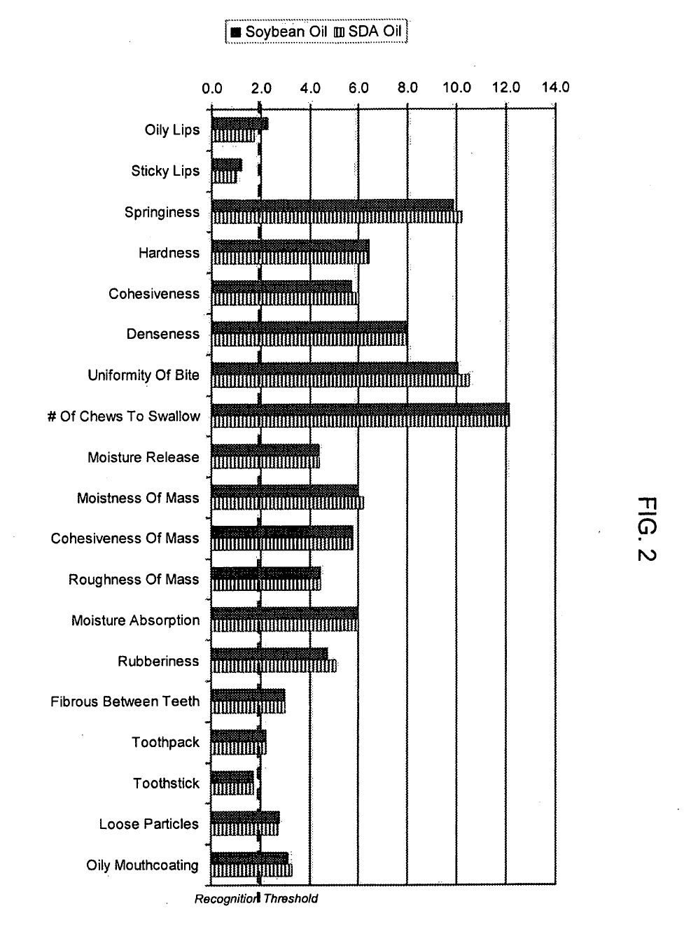

There were detectable differences between the soybean oil hotdog and SDA oil hotdog at time zero (0), shown in Tables 5 and 6. At time zero (0), the soybean oil hotdog was higher in spice complex, white/black pepper aromatics, oily lips, and sticky lips (FIGS. 1 and 2). The soybean oil hotdog sample did not have any fishy/pondy aromatics.

At time zero (0), the SDA oil hotdog was higher in springiness, cohesiveness, uniformity of bite, moistness of mass, and rubberiness (FIGS. 1 and 2). This sample had fishy/pondy aromatics, but below the recognition threshold (2.0); therefore, consumers would not be able to detect the fishy/pondy aromatics in the sample.

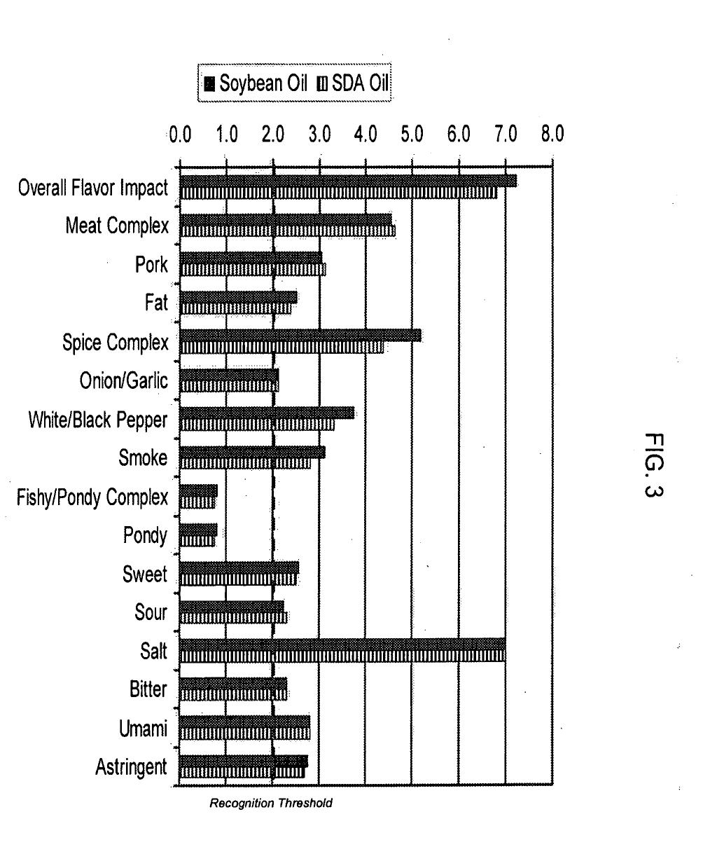

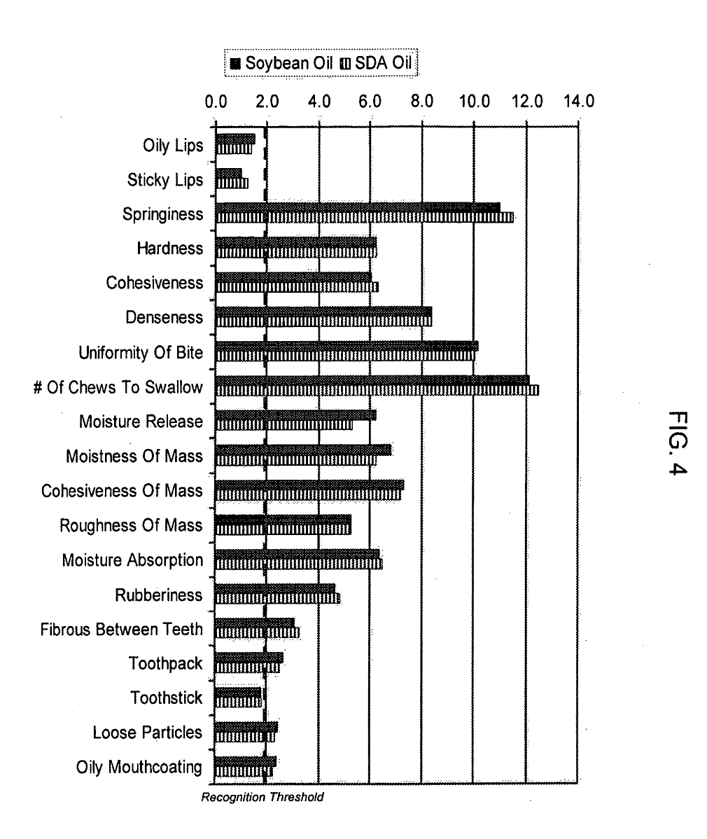

There were detectable differences between the soybean oil and SDA oil hotdog at 12 weeks, shown in Tables 7 and 8. At twelve (12) weeks, the soybean oil hotdog was higher in overall flavor, spice complex, white/black pepper aromatics, smoke aromatics, moisture release, and moistness of mass (FIGS. 3 and 4).

At twelve (12) weeks, the SDA oil hotdog was higher in sticky lips, springiness, and fibrous between teeth (FIGS. 3 and 4).

At twelve (12) weeks, both the soybean oil hotdog and SDA oil hotdog had nutmeg aromatics as well as fishy/pondy aromatics, but were below the recognition threshold (2.0), indicating consumers would not be able to detect these aromatics in the samples.

TABLE 5
Mean Scores for Flavor Attributes of Hotdogs at Time Zero (0)

| | Soybean Oil | SDA Oil | p value |
|---|---|---|---|
| Aromatics | | | |
| Overall Flavor Impact | 6.8 a | 6.8 a | NS |
| Meat Complex | 4.0 a | 4.0 a | NS |
| Pork | 2.9 a | 2.9 a | * |
| Fat | 2.4 a | 2.3 a | * |
| Beef | 0.6 a | 0.3 a | * |
| SWA | 0.0 | 0.0 | n/a |
| Spice Complex | 5.1 a | 5.0 b | ** |
| Onion/Garlic | 2.7 a | 2.6 a | * |
| White/Black Pepper | 4.1 a | 3.7 b | *** |
| Smoke | 2.9 a | 2.9 a | NS |
| Fishy/Pondy Complex | 0.0 a | 0.3 a | * |
| Fishy | 0.0 a | 0.3 a | * |
| Pondy | 0.0 | 0.0 | n/a |
| Basic Tastes & | | | |
| Feeling Factors | | | |
| Sweet | 1.7 a | 1.7 a | NS |
| Sour | 2.1 a | 2.1 a | NS |
| Salt | 4.9 a | 5.1 a | * |
| Bitter | 2.1 a | 2.1 a | NS |
| Umami | 2.5 a | 2.4 a | NS |
| Astringent | 2.5 a | 2.6 a | * |
| Metallic | 0.0 | 0.0 | n/a |
| Burn | 3.1 a | 3.0 a | NS |

¹Means in the same row followed by the same letter are not significantly different at 95% Confidence.
*** 99% Confidence,
** 95% Confidence,
* 90% Confidence,
NS—Not Significant
The attributes above threshold are bold.
The attributes significant at 90% Confidence are italicized.
For other attributes, % score is the percentage of times the attribute was perceived, and the score is reported as an average value of the detectors.

TABLE 6
Mean Scores for Texture Attributes of Hotdogs at Time Zero (0).

| | Soybean Oil | SDA Oil | p value |
|---|---|---|---|
| Suraface | | | |
| Oily Lips | 2.3 a | 1.7 b | *** |
| Sticky Lips | 1.2 a | 1.0 b | ** |
| Partial Compression | | | |
| Springiness | 9.9 b | 10.2 a | ** |
| First Bite | | | |
| Hardness | 6.4 a | 6.4 a | NS |
| Cohesiveness | 5.7 b | 6.0 a | *** |
| Denseness | 8.0 a | 8.0 a | NS |
| Uniformity Of Bite | 10.1 b | 10.5 a | ** |
| ChewDown | | | |
| # Of Chews To Swallow | 12.1 a | 12.1 a | NS |
| Moisture Release | 4.4 a | 4.4 a | NS |
| Moistness Of Mass | 5.9 b | 6.2 a | *** |
| Cohesiveness Of Mass | 5.8 a | 5.8 a | NS |
| Roughness Of Mass | 4.4 a | 4.4 a | NS |
| Moisture Absorption | 6.0 a | 6.0 a | NS |
| Rubberiness | 4.7 b | 5.1 a | ** |
| Fibrous Between Teeth | 3.0 a | 3.0 a | NS |
| Residual | | | |
| Toothpack | 2.2 a | 2.2 a | NS |
| Toothstick | 1.7 a | 1.7 a | NS |
| Loose Particles | 2.8 a | 2.7 a | NS |
| Oily Mouthcoating | 3.1 b | 3.3 ab | * |

[symbol]

Means in the same row followed by the same letter are not significantly different at 95% Confidence.
*** 99% Confidence,
** 95% Confidence,
* 90% Confidence,
NS—Not Significant
The attributes above threshold are bold.
The attributes significant at 90% Confidence are italicized.
For other attributes, % score is the percentage of times the attribute was perceived, and the score is reported as an average value of the detectors. [symbol]
indicates data missing or illegible when filed

TABLE 7
Mean Scores for Flavor Attributes of Hotdogs at 12 Weeks.

| Aromatics | Soybean Oil | SDA Oil | p value |
|---|---|---|---|
| Overall Flavor Impact | 7.2 a | 6.8 b | *** |
| Meat complex | 4.6 a | 4.6 a | NS |
| Pork | 3.1 a | 3.1 a | NS |
| Fat | 2.5 a | 2.4 a | * |
| Poultry | 0.0 | 0.0 | n/a |
| Beef | 0.0 | 0.0 | n/a |
| SWA | 0.0 | 0.0 | n/a |
| Spice Complex | 5.2 a | 4.4 b | *** |
| Onion/Garlic | 2.1 a | 2.1 a | NS |
| White/Black Pepper | 3.8 a | 3.3 b | *** |
| Smoke | 3.1 a | 2.8 b | *** |
| Fishy/Pondy Complex | 0.8 a | 0.8 a | * |
| Fishy | 0.0 | 0.0 | n/a |
| Pondy | 0.8 a | 0.8 a | * |
| Other Aromatic Nutmeg | 2.0 (38%) | 2.0 (25%) | |
| Basis Tastes & Feeling | | | |
| Factors | | | |
| Sweet | 2.6 a | 2.5 a | NS |
| Sour | 2.3 a | 2.3 a | * |
| Salt | 7.0 a | 7.0 a | NS |
| Bitter | 2.3 a | 2.3 a | NS |
| Umami | 2.8 a | 2.8 a | NS |
| Astringent | 2.8 a | 2.7 a | * |
| Metallic | 0.1 a | 0.1 a | NS |
| Burn | 3.0 a | 2.7 b | ** |

¹Means in the same row followed by the same letter are not significantly different at 95% Confidence.
*** 99% Confidence,
** 95% Confidence,
* 90% Confidence,
NS—Not Significant
The attributes above threshold are bold.
The attributes significant at 90% Confidence are italicized.
For other attributes, % score is the percentage of times the attribute was perceived, and the score is reported as an average value of the detectors.

TABLE 8
Mean Scores for Texture Attributes of Hotdogs at 12 Weeks.

| | Soybean Oil | SDA Oil | p value |
|---|---|---|---|
| Surface | | | |
| Oily Lips | 1.5 a | 1.4 a | NS |
| Sticky Lips | 1.0 b | 1.3 a | ** |
| Partial Compression | | | |
| Springiness | 11.0 b | 11.5 a | *** |
| First Bite | | | |
| Hardness | 6.3 a | 6.3 a | NS |
| Cohesiveness | 6.1 b | 6.3 a | ** |
| Denseness | 8.4 a | 8.4 a | NS |
| Uniformity Of Bite | 10.2 a | 10.1 a | NS |
| ChewDown | | | |
| # Of Chews To Swallow | 12.1 a | 12.5 a | * |
| Moisture Release | 6.3 a | 5.3 b | *** |
| Moistness Of Mass | 6.8 a | 6.3 b | *** |
| Cohesiveness Of Mass | 7.3 a | 7.2 a | NS |
| Roughness Of Mass | 5.3 a | 5.3 a | NS |
| Moisture Absorption | 6.4 a | 6.5 a | * |
| Rubberiness | 4.6 a | 4.8 a | NS |
| Fibrous Between Teeth | 3.1 b | 3.3 a | ** |
| Residual | | | |
| Toothpack | 2.6 a | 2.5 a | * |
| Toothstick | 1.8 a | 1.8 a | NS |
| Loose Particles | 2.4 a | 2.3 a | * |
| Oily Mouthcoating | 2.4 a | 2.3 a | * |

¹Means in the same row followed by the same letter are not significantly different at 95% Confidence.
*** 99% Confidence,
** 95% Confidence,
* 90% Confidence,
NS—Not Significant
The attributes above threshold are bold.
The attributes significant at 90% Confidence are italicized.
For other attributes, % score is the percentage of times the attribute was perceived, and the score is reported as an average value of the detectors.

### Example 3

### Dried Fermented Sausage (Pepperoni)

The following example delivers a quantity of SDA per serving size.

TABLE 9
Dried Fermented Sausage-Pepperoni Formulation

| | Control | SDA |
|---|---|---|
| | SBO | Test |
| Ingredients | Kg dry | Kg dry |
| Beef 70/30 | 22.00 | 22.00 |
| Pork shoulder trim | 23.79 | 23.79 |
| Pork trim 50/50 | 20.00 | 20.00 |
| Dextrose | 0.80 | 0.80 |
| Sodium ascorbate | 0.04 | 0.04 |
| Salt | 2.50 | 2.50 |
| Cure salt | 0.20 | 0.20 |
| Oleoresin paprika seasoning | 0.50 | 0.50 |
| Starter culture | 0.02 | 0.02 |
| SUPRO ® emulsion EX 45 with SBO | 30.15 | 0.00 |
| SUPRO ® emulsion EX 45 with SDA oil | 0.00 | 30.15 |
| TOTAL | 100.00 | 100.00 |

TABLE 10
SUPRO ® emulsion EX 45 Formulation with SBO or
SDA oil for Dried Fermented Sausage-Pepperoni

| | SBO Emulsion | | SDA Emulsion | |
|---|---|---|---|---|
| Ingredients | % | Kg | % | Kg |
| Water | 55.60 | 3.03 | 55.60 | 3.03 |
| SUPRO ® EX 45 | 22.20 | 1.21 | 22.20 | 1.21 |
| Soybean oil (SBO) | 22.20 | 1.21 | 0.00 | 0.00 |
| SDA enriched soybean oil | 0.00 | 0.00 | 22.20 | 1.21 |
| TOTAL | 100.00 | 5.45 | 100.00 | 5.45 |

The emulsion was prepared by first mixing the SUPRO® EX45, isolated soy protein (ISP), with water at a ratio of 1.2:3.0. The mixture of SUPRO® EX45, ISP and water was chopped in a chopper (Robot Coupe Cutter R8, Robot Coupe USA, Inc., Jackson, Miss.) for 3 minutes. The oil (SBO or SDA oil) was added to the mixture of SUPRO® EX45, ISP and water and the entire mixture was chopped for an additional 3 minutes to form an emulsion. The emulsion was then refrigerated until use.

The beef trim and pork shoulder trim were pre-ground using a Butcher Boy® Model A52 HF grinder (American Meat Equipment, LLC, Selmer, Tenn.) through a ½″ (13 mm) grinder plate. The pork trim 50/50 was tempered to −1° C. (30° F.) and ground through the ½″ (13 mm) grinder plate.

The ground meat and emulsion were mixed using a Tallers Cato mixer (Model AV50, Tellers Cato, S.A., Sabadell, Spain) during which time the starter culture, oleoresin paprika seasoning, and dextrose were added to the ground meat and emulsion mixture and mixed for 5 minutes.

The salt and cure salt were added to the ground meat and emulsion mixture and mixed for 2 minutes. The sodium ascorbate was added to the ground meat and emulsion mixture and mixed for an additional 1 minute.

The mixture was ground through 5/32″ grinder plate and stuffed into collagen casings (6 cm in diameter) using the Handtmann VF 200 filler (Handtmann, Buffalo Grove, Ill.).

The sausages were fermented at 37° C., 90-95% relative humidity, until a pH of 5.2 was attained (approximately 12-16 hours).

The sausages were cooked in an Alkar Thermal Processing Unit (Alkar-RapidPax, Inc., Lodi Wis.) to an internal temperature of 54° C. with a 30-minute hold time. They were then dried at 14° C. using a controlled relative humidity schedule to achieve an ultimate water activity of 0.80 to 0.85 and the final moisture to protein ratio of 1.6:1.0

The result was a dried fermented sausage that possessing an increased amount of SDA, but retaining the taste, aroma, structure, and mouthfeel of typical dried sausages.

### Example 4

### Sensory Profiling of Pepperoni (Dried Fermented Pork Sausage)

Sensory descriptive analysis was conducted on pepperoni to understand the attribute differences of soybean oil in pepperoni and SDA oil in pepperoni. There were fourteen (14) panelists; all the panelists were trained in the Sensory Spectrum™ Descriptive Profiling method. The fourteen (14) panelists evaluated the samples for twenty-five (25) flavor attributes and three (3) aftertaste attributes. The attributes were evaluated on a 15-point scale, with 0=none/not applicable and 15=very strong/high in each sample. Definitions of the flavor attributes are given in Table 11.

Each panelist received 2 slices of pepperoni and evaluated the pepperoni for flavor and aftertaste. The samples were presented monadically in duplicate.

The data were analyzed using the Analysis of Variance (ANOVA) to test product and replication effects. When the ANOVA result was significant, multiple comparisons of means were performed using the Tukey's HSD t-test. All differences were significant at a 95% confidence level unless otherwise noted. For flavor attributes, mean values<1.0 indicate that not all panelists perceived the attribute in the sample. A value of 2.0 was considered recognition threshold for all flavor attributes, which was the minimum level that the panelist could detect and still identify the attribute.

TABLE 11
Flavor Attribute Lexicon.

| Attribute | Definition | Reference | |
|---|---|---|---|
| | | Intensities based on Universal Scale: | |
| | | Baking Soda in Saltine | 2.5 |
| | | Cooked Apple in Applesauce | 5.0 |
| | | Orange in Orange Juice | 7.5 |
| | | Concord Grape in Grape Juice | 10.0 |
| | | Cinnamon in Big Red Gum | 12.0 |
| AROMATICS | | | |
| Overall Flavor Impact | The overall intensity of the product aromas, | | |
| | an amalgamation of all perceived aromatics, | | |
| | basic tastes and chemical feeling factors. | | |
| Meat Complex | | | |
| Beef | The animal/blood/marrow aromatic | Cooked (boiled) lean ground beef | |
| | associated with lean red meat. | | |
| Pork | The garney, cardboardy aromatic associated | Ground pork, Pork trimmed of | |
| | with cooked/cured lean pork | visible fat. | |
| Poultry | Aromatics associated white/dark meat | Boiled white/dark meat turkey | |
| | turkey | | |
| Fat | Aromatic reminiscent of dairy lipid | Melted butter, Crisco, boiled | |
| | products, melted vegetable shortening | chicken skins, beef tallow. | |
| | cooked chicken skin, and beef tallow | | |
| Oily | The aroma and flavor notes reminiscent of | Vegetable Oil | |
| | vegetable oil | | |
| Spice Complex | | | |
| Onion/Garlic/Celery | The aromatics associated with dehydrated | Onion, garlic and celery powder | |
| | onion, garlic and celery powders | solutions. Garlic Oil Capsules | |
| White/Black Pepper | The aromatic associated with white and | White pepper and black pepper | |
| | black pepper | solutions | |
| Paprika | The aromatic associated with paprika | Paprika solution | |
| Cayenne pepper | The spicy aromatics associated with red | Cayenne pepper and chili powder | |
| | pepper | solutions | |
| Other (type) | | | |
| Fishy/Pondy Complex | The aroma/aromatics associated with | | |
| | triethylamine, pond water or aged fish. The | | |
| | general term used to describe fish meat, | | |
| | which cannot be tied to a specific fish by | | |
| | name. | | |
| Fishy | Aromatic associated with trimethylamine | Cod liver oil capsules, | |
| | and old fish. | trimethylamine, Geisha canned | |
| | | lump crab, tuna in pouch | |
| Pondy | The aromas and aromatics associated with | Algal oil (Martek 30% DHA oil) | |
| | water containing algae, reminiscent of pond | | |
| | water and aquatic tanks. | | |
| Smoke | The aromatic associated with of any type of | Colgin Natural Hickory Liquid | |
| | smoke flavor. | Smoke | |
| Vinegar | The aromatics associated with vinegar | White vinegar | |
| BASIC TASTES | | | |
| | | Sucrose solution: | |
| Sweet | The taste on the tongue stimulated by sucrose | 2% | 2.0 |
| | and other sugars, such as fructose, glucose, etc., | 5% | 5.0 |
| | and by other sweet substances, such as | 10% | 10.0 |
| | saccharin, Aspartame, and Acesulfam-K. | 16% | 15.0 |
| | | Citric acid solution: | |
| Sour | The taste on the tongue stimulated by acid, such | 0.05% | 2.0 |
| | as citric, malic, phosphoric, etc. | 0.08% | 5.0 |
| | | 0.15% | 10.0 |
| | | 0.20% | 15.0 |
| | | Sodium chloride solution: | |
| Salt | The taste on the associated with sodium | 0.2% | 2.0 |
| | salts. | 0.35% | 5.0 |
| | | 0.5% | 8.5 |
| | | 0.57% | 10.0 |
| | | 0.7% | 16.0 |
| | | Caffeine solution: | |
| Bitter | The taste on the tongue associated with caffeine | 0.05% | 2.0 |
| | and other bitter substances, such as quinine and | 0.08% | 5.0 |
| | hop bitters. | 0.15% | 10.0 |
| | | 0.20% | 15.0 |
| | | MSG solution | |
| Umami | The taste on the tongue associated with | 6% | 5.0 |
| | monosodium glutamate. Savory. | | |
| CHEMICAL FEELING | | | |
| FACTOR | | | |
| | | Alum solution: | |
| Astringent | The shrinking or puckering of the tongue surface | 0.05% | 3.0 |
| | caused by substances such as tannins or alum. | 0.10% | 6.0 |
| | | 0.2% | 9.0 |

| | | |
|---|---|---|
| Burn | A chemical feeling factor associated with high | Lemon juice, vinegar. |
| | concentration of irritants to the mucous | |
| | membranes of the oral cavity. When reported, | |
| | this sensation should be further characterized by | |
| | the “type” of burn (eg., sweet burn, salt burn, | |
| | bitter burn, chemical burn) if possible. Lower | |
| | intensities of “Burn” may also be described by a | |
| | type of irritation sensation (eg., numbing, tingle, | |
| | prickly, stinging) | |

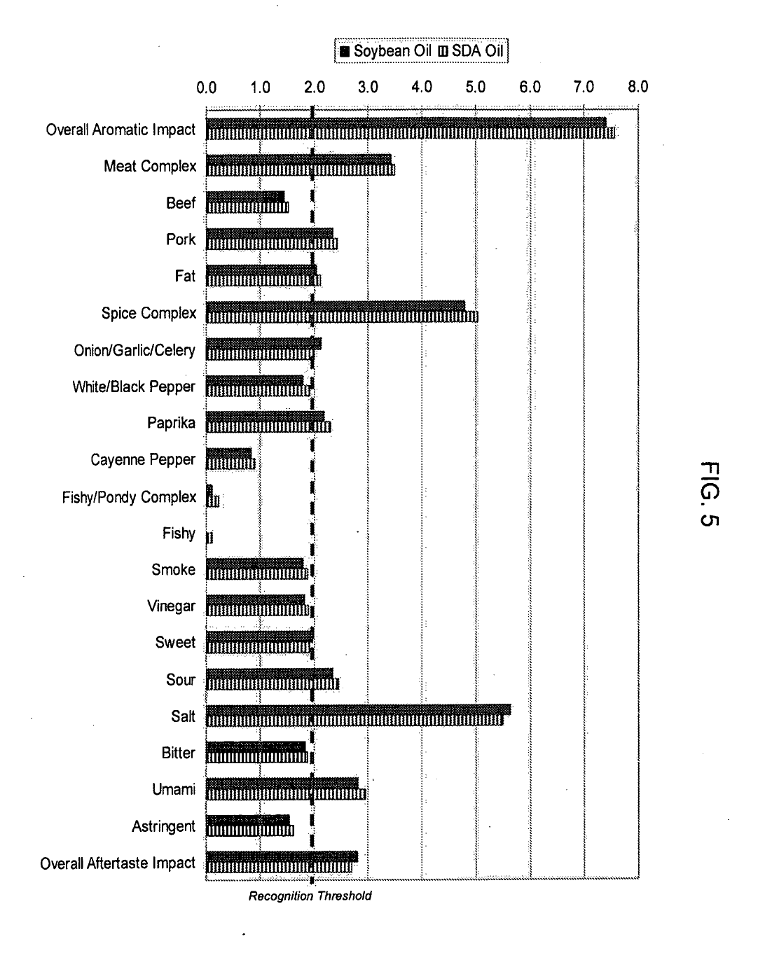

There were no significant differences across sensory characteristics between the soybean oil pepperoni and SDA oil pepperoni, shown in Table 12. The fishy/pondy aromatics in the soybean oil pepperoni and the SDA oil pepperoni were below the recognition threshold (2.0), indicating consumers would not be able to detect the fishy/pondy aromatics in the samples (FIG. 5).

Both the soybean oil pepperoni and SDA oil pepperoni had oil aromatics, cardboard/woody aromatics, spice oregano aromatics, and heat feeling factor, while only the SDA oil pepperoni had fennel aromatics.

TABLE 12
Mean Scores for Flavor Attributes and Aftertaste Attributes of Pepperoni

| | Soybean | SDA | | |
|---|---|---|---|---|
| Aromatics | Oil | value | HSD value | p value |
| Overall Aromatic Impact | 7.4 a | 7.6 a | 0.210 | NS |
| Meat Complex | 3.4 a | 3.5 a | 0.156 | NS |
| Beef | 1.5 a | 1.5 a | 0.324 | NS |
| Pork | 2.3 a | 2.4 a | 0.218 | NS |
| Poultry | 0.1 a | 0.0 a | 0.183 | NS |
| Fat | 2.1 a | 2.1 a | 0.220 | NS |
| Oily | 0.0 a | 0.2 a | 0.226 | * |
| Spies Complex | 4.8 a | 5.0 a | 0.303 | NS |
| Onion/Garlic/Celery | 2.1 a | 2.0 a | 0.306 | NS |
| White/Black Pepper | 1.8 a | 1.9 a | 0.221 | NS |
| Paprika | 2.2 a | 2.3 a | 0.172 | NS |
| Cayenne Pepper | 0.8 a | 0.9 a | 0.222 | NS |
| Other Spice | 0.1 a | 0.3 a | 0.180 | NS |
| Fishy/Pondy Complex | 0.1 a | 0.2 a | 0.157 | MS |
| Fishy | 0.0 a | 0.1 a | 0.153 | NS |
| Pondy | 0.0 | 0.0 | n/a | n/a |
| Smoke | 1.8 a | 1.9 a | 0.283 | NS |
| Vinegar | 1.8 a | 1.9 a | 0.137 | NS |
| Other: Oil | 1.6 (36%) | 1.6 (29%) | | |
| Other: Cardboard/Woody | 2.0 (14%) | 2.0 (14%) | | |
| Other: Spice Oregano | 1.5 (7%) | 1.5 (7%) | | |
| Other: Fennel | | 1.5 (7%) | | |
| Basic Tastes & | | | | |
| Feeling Factors | | | | |
| Sweet | 2.0 a | 1.9 a | 0.143 | NS |
| Sour | 2.3 a | 2.5 a | 0.200 | NS |
| Salt | 5.6 a | 5.5 a | 0.362 | NS |
| Bitter | 1.8 a | 1.9 a | 0.081 | NS |
| Umami | 2.8 a | 3.0 a | 0.353 | NS |
| Astringent | 1.5 a | 1.6 a | 0.159 | NS |
| Burn | 0.6 a | 0.6 a | 0.122 | NS |
| Other FF: Heat | 1.7 (50%) | 1.9 (50%) | | |
| Aftertaste | | | | |
| Overall Aftertaste Impact | 2.8 a | 2.7 a | 0.201 | NS |
| Fishy Aftertaste | 0.0 | 0.0 | n/a | n/a |
| Pondy Aftertaste | 0.0. | 0.0. | n/a | n/a |

¹Means in the same row followed by the same letter are not significantly different at 95% Confidence.
***99% Confidence,
**95% Confidence,
* 90% Confidence,
NS—Not Significant
The attributes above threshold are bold.
The attributes significant at 90% Confidence are italicized.
For other attributes, % score is the percentage of times the attribute was perceived, and the score is reported as an average value of the detectors.

### Example 5

### Fresh Pork Sausage

The following example relates to a method of forming a fresh pork sausage, which delivers a quantity of SDA oil per serving.

The pork trim from Table 13 was pre-ground using a Butcher Boy® Model A52 HF grinder to ⅜″ (9.5 mm) grinder plate.

The pre-ground pork trim was mixed with the remaining dry ingredients, water, and oil in a Tallers Cato mixer (Model AV50, Tallers Cato S.A., Sabadell, Spain) for 3 minutes.

The mixture was ground through a ⅛″ (3 mm) grinder plate using a Butcher Boy® Model A52HF grinder (American Meat Equipment, LLC., Selmer, Tenn.).

The mixture was then stuffed into collagen casings using the Handtmann VF200 filler (Handtmann, Buffalo Grove, Ill.) and stored frozen at −18° C.

The result was a fresh pork sausage having a quantity of SDA per serving, but retaining the taste, aroma, structure, and mouthfeel of traditional fresh pork sausages.

TABLE 13
Fresh Pork Sausage Formulation

| | Control SBO | | SDA | |
|---|---|---|---|---|
| Ingredients | % | Kg | % | Kg |
| Pork trim (80/20) | 87.21 | 87.21 | 87.21 | 87.21 |
| Water/ice | 5.50 | 5.50 | 5.50 | 5.50 |
| Sucrose | 0.63 | 0.63 | 0.63 | 0.63 |
| Salt | 1.50 | 1.50 | 1.50 | 1.50 |
| Ground white pepper | 0.21 | 0.21 | 0.21 | 0.21 |
| Sage | 0.11 | 0.11 | 0.11 | 0.11 |
| Red pepper | 0.05 | 0.05 | 0.05 | 0.05 |
| Ginger | 0.05 | 0.05 | 0.05 | 0.05 |
| HVF 53* | 1.50 | 1.50 | 1.50 | 1.50 |
| Soybean oil (SBO) | 3.24 | 3.24 | 0.00 | 0.00 |
| SDA enriched soybean oil | 0.00 | 0.00 | 3.24 | 3.24 |
| Total | 100.00 | 100.00 | 100.00 | 100.00 |

*hydrolyzed vegetable protein (Solae, LLC., St. Louis, MO)

### Example 6

### Sensory Profiling of Pork Sausage

Sensory descriptive analysis was conducted on pork sausage to understand the attribute differences of soybean oil and SDA oil in pork sausage. There were ten (10) panelists; all the panelists were trained in the Sensory Spectrum™ Descriptive Profiling method. The ten (10) panelists evaluated the samples for thirty-two (32) flavor attributes and three (3) aftertaste attributes. The attributes were evaluated on a 15-point scale, with 0=none/not applicable and 15=very strong/high in each sample. Definitions of the flavor attributes are given in Table 14.

The pork sausage was cooked on a flat top griddle until they reached an internal temperature of 71° C. (160° F.). Each panelist received one link. The ends of the sausage were removed and the sausage was cut into quarters. Each panelist received a quarter of each sausage link and evaluated it for flavor and aftertaste. The samples were presented monadically in duplicate.

The data were analyzed using the Analysis of Variance (ANOVA) to test product and replication effects. When the ANOVA result was significant, multiple comparisons of means were performed using the Tukey's NSD t-test. All differences were significant at a 95% confidence level unless otherwise noted. For flavor attributes, mean values<1.0 indicate that not all panelists perceived the attribute in the sample. A value of 2.0 was considered recognition threshold for all flavor attributes, which was the minimum level that the panelist could detect and still identify the attribute.

TABLE 14
Breakfast Sausage (Omega-3) Flavor Lexicon

| Attribute | Definition | Reference | |
|---|---|---|---|
| | | Intensities based on Universal Scale: | |
| Aromatics | | Baking Soda in Saltine | 2.5 |
| | | Cooked Apple in Applesauce | 5.0 |
| | | Orange in Orange Juice | 7.5 |
| | | Concord Grape in Grape Juice | 10.0 |
| | | Cinnamon in Big Red Gum | 12.0 |
| Overall Flavor | The amalgamation of all perceived flavors, | | |
| Impact | including aromatics, basic tastes and chemical | | |
| | feeling factors. | | |
| Meat Complex | The general category used to describe the total | | |
| | beef flavor impact of the product | | |
| Pork | The gamey, cardboardy aromatic associated with | Ground pork, Pork trimmed | |
| | cooked/cured lean pork | of visible fat. | |
| Beef | The animal/blood/marrow aromatic associated | Boiled lean ground beef | |
| | with lean red meat. | | |
| Poultry | Aromatics associated with white/dark meat | Boiled white/dark meat | |
| | turkey | turkey | |
| Browned/ | The aromatic associated with the outside of | Broiled meat, roasted chicken | |
| Caramelized/ | grilled or broiled meat. | breast | |
| Roasted | | | |
| SWA | The general category of aromatics associated with | Vanilla, molasses, honey, etc. | |
| | sweet foods (confectionary). | | |
| Spice Complex | The general category used to describe the total | | |
| | spice flavor impact of the product. | | |
| Onion/Garlic/ | The aromatics associated with dehydrated onion, | Onion, garlic and celery | |
| Celery | garlic and celery powders | powder solutions. Garlic Oil | |
| | | Capsules | |
| White/Black | The aromatic associated with white and black | White pepper and black | |
| Pepper | pepper | pepper solutions | |
| Cayenne Pepper | The spicy aromatic associated with red pepper | Cayenne pepper and chili | |
| | | powder solutions | |
| Green Herb | The aromatics associated with fresh or dried | Oregano, thyme, basil, bay, | |
| | herbs | sage, parsley, etc. | |
| Brown Spice | The aromatic associated with cloves, cinnamon, | Clove/Cinnamon/Nutmeg | |
| | mace and nutmeg | solution | |
| Other Spices | | | |
| (type) | | | |
| Fat | Aromatic reminiscent of dairy lipid products, | Melted butter, Crisco, boiled | |
| | melted vegetable shortening cooked chicken skin, | chicken skins, beef tallow. | |
| | and beef tallow | | |
| Soy/Legume | The earthy/dirty, green aromatics associated with | Unsweetened Silk, Canned | |
| | legumes/soybeans; may include all types and | Soybeans, Tofu | |
| | different stages of heating. | | |
| TVP | The woody, vegetative aromatic associated with | Hydrated TVP | |
| | cooked texturized vegetable protein | | |
| Fishy/Pondy | The aroma/aromatics associated with | | |
| Complex | triethylamine, pond water or aged fish. The | | |
| | general term used to describe fish meat, which | | |
| | cannot be tied to a specific fish by name. | | |
| Fishy | Aromatic associated with trimethylamine and old | Temperature abused | |
| | fish. | mackerel | |
| | | Container or Cod fish oil | |
| | | supplements, tuna in pouch | |
| Pondy | The aromas and aromatics associated with water | Algal oil (Martek 30% DHA | |
| | containing algae, reminiscent of pond water and | oil) | |
| | aquatic tanks. | | |
| Smoke | The aromatic associated with any type of smoke | Colgin Natural Hickory | |
| | flavor. | Liquid Smoke | |
| Metallic | The aromatic associated with metals, tin or iron. | Iron tablet, canned tomato | |
| | | juice, pennies | |
| Cardboard/ | The aromatics associated with dried wood and the | Toothpicks, Water from | |
| Woody | aromatics associated with slightly oxidized fats | cardboard soaked for 1 hour | |
| | and oils, reminiscent of a cardboard box. | | |
| Painty | The solvent aromatic associated with linseed oils | Aroma of linseed Oil | |
| | and moderately oxidized oil. | | |
| BASIC TASTES | | | |
| | | Sucrose solution: | |
| Sweet | The taste on the tongue stimulated by | 2% | 2.0 |
| | sucrose and other sugars, such as fructose, | 5% | 5.0 |
| | glucose, etc., and by other sweet | 10% | 10.0 |
| | substances, such as saccharin, Aspartame, | 16% | 15.0 |
| | and Acesulfam-K. | | |
| | | Citric acid solution: | |
| Sour | The taste on the tongue stimulated by acid, | 0.05% | 2.0 |
| | such as citric, malic, phosphoric, etc. | 0.08% | 5.0 |
| | | 0.15% | 10.0 |
| | | 0.20% | 15.0 |
| | | Sodium chloride solution: | |
| Salt | The taste on the tongue associated with | 0.2% | 2.0 |
| | sodium salts. | 0.35% | 5.0 |
| | | 0.5% | 8.5 |
| | | 0.57% | 10.0 |
| | | 0.7% | 16.0 |
| | | Caffeine solution: | |
| Bitter | The taste on the tongue associated with | 0.05% | 2.0 |
| | caffeine and other bitter substances, such | 0.08% | 5.0 |
| | as quinine and hop bitters. | 0.15% | 10.0 |
| | | 0.20% | 15.0 |
| | | MSG solution: | |
| Umami | The taste on the tongue associated with | 6% | 5.0 |
| | monosodium glutamate. Savory. | | |
| CHEMICAL FEELING | | | |
| FACTOR | | | |
| | | Alum solution: | |
| Astringent | The shrinking or puckering of the tongue | 0.05% | 3.0 |
| | surface caused by substances such as | 0.10% | 6.0 |
| | tannins or alum. | 0.2% | 9.0 |

| | | |
|---|---|---|
| Burn | A chemical feeling factor associated with | Lemon juice, vinegar. |
| | high concentration of irritants to the mucous | |
| | membranes of the oral cavity. When | |
| | reported, this sensation should be further | |
| | characterized by the “type” of burn | |
| | (eg..sweet burn, salt burn, bitter burn, | |
| | chemical burn) if possible. Lower intensities | |
| | of “Burn” may also be described by a type | |
| | of irritation sensation (eg..numbing, tingle, | |
| | prickly, stinging) | |

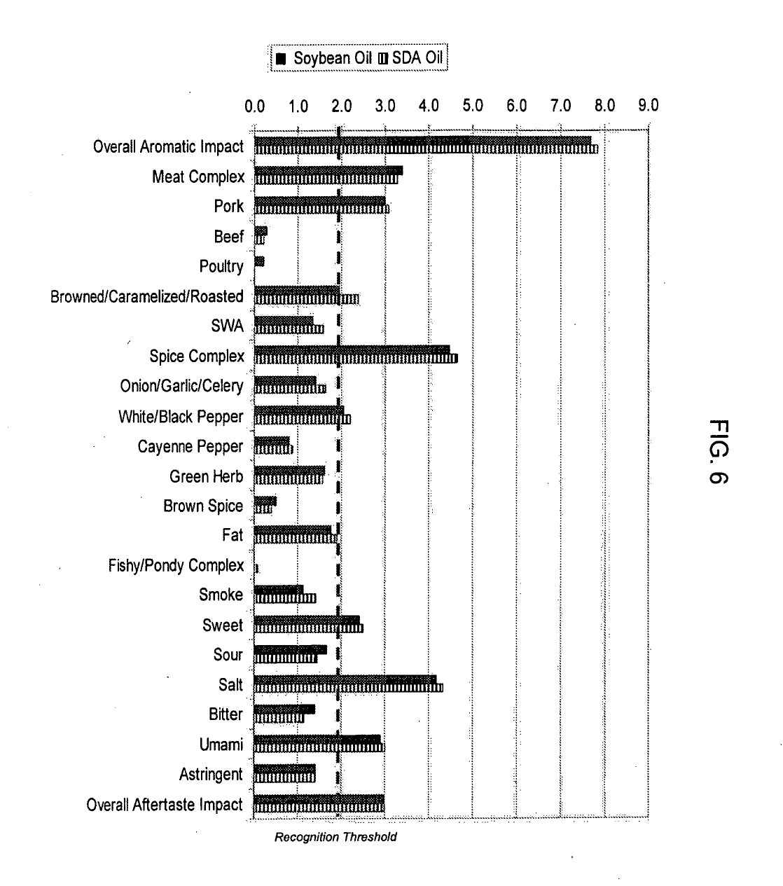

There were detectable differences between the soybean oil pork sausage and SDA oil pork sausage, shown in Table 15. The soybean oil pork sausage was higher in browned/caramelized/roasted aromatics and smoke aromatics (FIG. 6).

The soybean oil pork sausage and SDA oil pork sausage had heat feeling factor. The fishy/pondy aromatics found in SDA oil pork sausage and fishy aftertaste found in both the soybean oil pork sausage and SDA oil pork sausage were below the recognition threshold (2.0), indicating consumers would not be able to detect these aromatics in the samples (FIG. 6).

TABLE 15
Mean Scores for Flavor Attributes and Aftertaste Attributes of Pork
Sausage

| | Soybean | | HSD | |
|---|---|---|---|---|
| Aromatics | Oil | SDA Oil | value | p value |
| Overall Aromatic Impact | 7.7 a | 7.8 a | 0.353 | NS |
| Meat Complex | 3.4 a | 3.3 a | 0.339 | NS |
| Pork | 3.0 a | 3.1 a | 0.333 | NS |
| Beef | 0.3 a | 0.2 a | 0.330 | NS |
| Poultry | 0.2 a | 0.0 a | 0.326 | NS |
| Browned/Caramelized/Roasted | 2.0 b | 2.4 a | 0.382 | ** |
| SWA | 1.4 a | 1.6 a | 0.376 | NS |
| Spice Complex | 4.5 a | 4.7 a | 0.544 | NS |
| Onion/Garlic/Celery | 1.4 a | 1.6 a | 0.267 | NS |
| White/Black Pepper | 2.1 a | 2.2 a | 0.305 | NS |
| Cayenne Pepper | 0.8 a | 0.9 a | 0.693 | NS |
| Green Herb | 1.6 a | 1.6 a | 0.321 | NS |
| Brown Spice | 0.5 a | 0.4 a | 0.163 | NS |
| Other Spice | 0.0 | 0.0 | n/a | n/a |
| Fat | 1.8 a | 1.9 a | 0.303 | NS |
| Soy/Legume | 0.0 | 0.0 | n/a | n/a |
| TVP | 0.2 a | 0.3 a | 0.419 | NS |
| Fishy/Pondy Complex | 0.0 a | 0.1 a | 0.157 | NS |
| Fishy | 0.0 | 0.0 | n/a | n/a |
| Pondy | 0.0 | 0.0 | n/a | n/a |
| Smoke | 1.1 b | 1.4 a | 0.288 | ** |
| Metallic | 0.4 a | 0.5 a | 0.234 | NS |
| Cardboard/Woody | 0.6 a | 0.6 a | n/a | NS |
| Painty | 0.0 | 0.0 | n/a | n/a |
| Basic Tastes & Feeling Factors | | | | |
| Sweet | 2.4 a | 2.5 a | 0.374 | NS |
| Sour | 1.7 a | 1.5 a | 0.344 | NS |
| Salt | 4.2 a | 4.3 a | 0.188 | NS |
| Bitter | 1.4 a | 1.2 a | 0.426 | NS |
| Umami | 2.9 a | 3.0 a | 0.290 | NS |
| Astringent | 1.4 a | 1.4 a | n/a | NS |
| Metallic FF | 0.1 a | 0.1 a | 0.228 | 1.000 |
| Pepper Burn | 1.2 a | 1.2 a | 0.308 | 0.867 |
| Other FF: Heat | 1.9 (35%) | 1.7 (30%) | | |
| Aftertaste | | | | |
| Overall Aftertaste Impact | 3.0 a | 3.0 a | 0.323 | 0.949 |
| Fishy Aftertaste | 0.1 a | 0.1 a | 0.052 | 0.330 |
| Pondy Aftertaste | 0.0 | 0.0 | n/a | n/a |

¹Means in the same row followed by the same letter are not significantly different at 95% Confidence.
***99% Confidence,
** 95% Confidence,
*90% Confidence,
NS—Not Significant
The attributes above threshold are bold.
The attributes significant at 90% Confidence are italicized.
For other attributes, % score is the percentage of times the attribute was perceived, and the score is reported as an average value of the detectors.

### Example 7

### Cooked Ham

The following examples relate to a method of forming a cooked ham, which delivers a quantity of SDA per serving.

TABLE 16
Formulation of Smoked Ham

| | Control SBO | | | SDA | | |
|---|---|---|---|---|---|---|
| | | | Green | | | Green |
| | Brine | | weight | Brine | | weight |
| Ingredients | % | Kg | Kg | % | Kg | Kg |
| Deboned ham | | | 62.50 | | | 62.50 |
| Ice/chilled | 69.11 | 69.11 | 25.91 | 69.11 | 69.11 | 25.91 |
| tap water | | | | | | |
| Supro ® 248 | 6.00 | 6.00 | 2.25 | 6.00 | 6.00 | 2.25 |
| Salt | 4.80 | 4.80 | 1.80 | 4.80 | 4.80 | 1.80 |
| Dextrose | 5.33 | 5.33 | 2.00 | 5.33 | 5.33 | 2.00 |
| Corn syrup | 5.33 | 5.33 | 2.00 | 5.33 | 5.33 | 2.00 |
| solids 43% | | | | | | |
| DE | | | | | | |
| Sodium | 0.93 | 0.93 | 0.35 | 0.93 | 0.93 | 0.35 |
| tripoly- | | | | | | |
| phosphate | | | | | | |
| Cure salt | 0.42 | 0.42 | 0.16 | 0.42 | 0.42 | 0.16 |
| Erythorbate | 0.09 | 0.09 | 0.03 | 0.09 | 0.09 | 0.03 |
| Soybean oil | 7.99 | 7.99 | 3.00 | 0.00 | 0.00 | 0.00 |
| (SBO) | | | | | | |
| SDA enriched | 0.000 | 0.000 | 0.000 | 7.99 | 7.99 | 3.00 |
| soybean oil | | | | | | |
| Total | 100.00 | 100.00 | 100.00 | 100.00 | 100.00 | 100.00 |

### Brine Preparation

Sodium tripolyphosphate was dissolved in ice/chilled tap water in order to achieve a final brine temperature of 4.5° C. (40° F.) using an Admix Rotosolver mixer (Model XP02, Admix, Inc., Manchester, N.H.) with continuous high shear.

SUPRO® 248 (Solae, LLC, St. Louis, Mo.), isolated soy protein, was added to the sodium tripolyphosphate solution and mixed using the Admix Rotosolver mixer until evenly suspended to form a protein dispersion.

SDA enriched soybean oil was incorporated into the protein dispersion using the Admix Rotosolver mixer with continuous high shear.

Sugar was dissolved into the protein and oil dispersion with continuous high shear mixing using the Admix Rotosolver mixer.

Salt and cure salt were then added to the protein dispersion and mixed using the Admix Rotosolver mixer until completely dissolved, thus forming a brine.

Erythorbate was added to the brine with continuous high shear mixing until dissolved into the brine using the Admix Rotosolver mixer.

### Injection and Tumbling Procedures

The deboned ham meat was trimmed to remove excess fat and connective tissue.

A multi-needle meat injector (Wolfking-Belam MI 650-306 injector, CFS Inc., Bakel, The Netherlands) was used to disperse the brine solution into the deboned ham meat, using 4 mm needles. The brine was agitated before and during injection to optimize suspension of the ingredients. Multiple passes through the injector were required to achieve the targeted pump level (extension 60% on a deboned ham basis).

The injected ham meat was then macerated to a depth of % to ½ inch (6 to 13 mm) to increase surface area of the injected ham meat using a Stork Protecon macerator (Model PMT 41, Gainesville, Ga.).

The injected macerated ham meat was tumbled in a vacuum tumbler (Inject Star Tumbler, Model HS-130, Mountain View, Ark.) at 16 rpm for 2 hours. Vacuum tumbling removed extraneous air and provided extraction of salt soluble proteins required to enhance binding of muscle groups together and imparting desired texture to meat after cooking.

The injected macerated ham was then refrigerated (at 5° C.) for 12 hours.

The cooked ham was then refrigerated until the cooked ham reached a temperature of 5° C. The cooked ham was then vacuum packaged (Vacuum Packaging Machine, Model 450-T, Sipromac, Inc., St-Germain, Canada) and refrigerated.

The result was cooked ham that has a quantity of SDA while retaining the taste, aroma, structure, and mouthfeel of typical cooked ham.

### Example 8

### Sensory Profiling of Cooked Ham

Sensory descriptive analysis was conducted on cooked ham to understand the attribute differences of soybean oil in cooked ham and SDA oil in cooked ham. There were fourteen (14) panelists; all the panelists were trained in the Sensory Spectrum™ Descriptive Profiling method. The fourteen (14) panelists evaluated the samples for twenty-six (26) flavor attributes and three (3) aftertaste attributes. The attributes were evaluated on a 15-point scale, with 0=none/not applicable and 15=very strong/high in each sample. Definitions of the flavor attributes are given in Table 17.

Each panelists received one slice of cooked ham then panelists evaluated ⅛ piece for flavor and aftertaste. The samples were presented monadically in duplicate.

The data were analyzed using the Analysis of Variance (ANOVA) to test product and replication effects. When the ANOVA result was significant, multiple comparisons of means were performed using the Tukey's HSD t-test. All differences were significant at a 95% confidence level unless otherwise noted. For flavor attributes, mean values<1.0 indicate that not all panelists perceived the attribute in the sample. A value of 2.0 was considered recognition threshold for all flavor attributes, which was the minimum level that the panelist could detect and still identify the attribute.

TABLE 17
Ham (Omega-3) Flavor Lexicon

| Attribute | Definition | Reference | |
|---|---|---|---|
| | | Intensities based on Universal Scale: | |
| | | Baking Soda in Saltine | 2.5 |
| | | Cooked Apple in | 5.0 |
| | | Applesauce | |
| | | Orange in Orange Juice | 7.5 |
| | | Concord Grape in Grape Juice | 10.0 |
| | | Cinnamon in Big Red Gum | 12.0 |
| Overall Flavor | The amalgamation of all perceived flavors, | | |
| Impact | including aromatics, basic tastes and chemical | | |
| | feeling factors. | | |
| Meat Complex | The general category used to describe the | | |
| | total Meat flavor impact of the product | | |
| Pork | The gamey, cardboardy aromatic associated | Ground pork, Pork trimmed of | |
| | with cooked/cured lean pork | visible fat. | |
| Poultry | Aromatics associated white white/dark meat | Boiled white/dark meat turkey | |
| | turkey | | |
| SWA Complex | The general category of aromatics associated | | |
| | with sweet foods (confectionary). | | |
| Caramelized | The aromatics associated with browned | Caramelized sugar, Caramel | |
| | sugars such as caramel. | candy, Pepperidge Farm | |
| | | Bordeaux cookies | |
| Maple | A sweet aromatic characterized as a | Maple syrup | |
| | caramelized, woody, vanilla-like blend of | | |
| | notes | | |
| Corn Syrup | Flavor associated with products sweetened | Dark Corn Syrup, Light corn | |
| | with corn syrup. | syrup | |
| Molasses | An aromatic associated with molasses; has a | Molasses | |
| | sharp, slight sulfur and or caramelized | | |
| | character. | | |
| Other SWA | | | |
| Smoke | The aromatic associated with any type of | Colgin Natural Hickory Liquid | |
| | smoke flavor. | Smoke | |
| Fat | Aromatic reminiscent of dairy lipid products, | Melted butter, Crisco, boiled | |
| | melted vegetable shortening cooked chicken | chicken skins, beef tallow. | |
| | skin, and beef tallow | | |
| Fishy/Pondy | The aroma/aromatics associated with | | |
| Complex | triethylamine, pond water or aged fish. The | | |
| | general term used to describe fish meat, | | |
| | which cannot be tied to a specific fish by | | |
| | name. | | |
| Fishy | Aromatic associated with trimethylamine and | Temperature abused mackerel | |
| | old fish. | Container of Cod fish oil | |
| | | supplements, tuna in pouch | |
| Pondy | The aromas and aromatics associated with | Algal oil (Martek 30% DHA | |
| | water containing algae, reminiscent of pond | oil) | |
| | water and aquatic tanks. | | |
| Metallic | The aromatic associated with metals, tin or | Iron tablet, canned tomato juice, | |
| | iron. | pennies | |
| Cardboard/Woody | The aromatics associated with dried wood | Toothpicks, Water from | |
| | and the aromatics associated with slightly | cardboard soaked for 1 hour | |
| | oxidized fats and oils, reminiscent of a | | |
| | cardboard box. | | |
| Painty | The solvent aromatics associated with linseed | Aroma of linseed oil | |
| | oils and moderately oxidized oil. | | |
| Basic Tastes | | | |
| | | Sucrose solution: | |
| Sweet | The taste on the tongue stimulated by sucrose and | 2% | 2.0 |
| | other sugars, such as fructose, glucose, etc., and | 5% | 5.0 |
| | by other sweet substances, such as saccharin, | 10% | 10.0 |
| | Aspartame, and Acesulfam-K. | 16% | 15.0 |
| | | Citric acid solution: | |
| Sour | The taste on the tongue stimulated by acid, such | 0.05% | 2.0 |
| | as citric, malic, phosphoric, etc. | 0.08% | 5.0 |
| | | 0.15% | 10.0 |
| | | 0.20% | 15.0 |
| | | Sodium chloride solution: | |
| Salt | The taste on the tongue associated with sodium | 0.2% | 2.0 |
| | salts. | 0.35% | 5.0 |
| | | 0.5% | 8.5 |
| | | 0.57% | 10.0 |
| | | 0.7% | 16.0 |
| | | Caffeine solution: | |
| Bitter | The taste on the tongue associated with caffeine | 0.05% | 2.0 |
| | and other bitter substances, such as quinine and | 0.08% | 5.0 |
| | hop bitters. | 0.15% | 10.0 |
| | | 0.20% | 15.0 |
| | | MSG solution: | |
| Umami | The taste on the tongue associated with | 6% | 5.0 |
| | monosodium glutamate, Savory. | | |
| CHEMICAL | | | |
| FEELING | | | |
| FACTORS | | | |
| | | Alum solution | |
| Astringent | The shrinking or puckering of the tongue surface | 0.05% | 3.0 |
| | caused by substances such as tannins or alum. | 0.0666% | 5.0 |
| | | 0.1% | 9.0 |

| | | |
|---|---|---|
| Metallic | A flat chemical feeling factor stimulated on the | Ferrous sulfate |
| | tongue by metal coins | |
| Burn | A chemical feeling factor associated with high | Lemon juice, vinegar. |
| | concentration of irritants to the mucous | |
| | membranes of the oral cavity. When reported, | |
| | this sensation should be further characterized by | |
| | the “type” of burn (eg..sweet burn, salt burn, | |
| | bitter burn, chemical burn) if possible. Lower | |
| | intensities of “Burn” may also be described by a | |
| | type of irritation sensation (eg..numbing, tingle, | |
| | prickly, stinging) | |

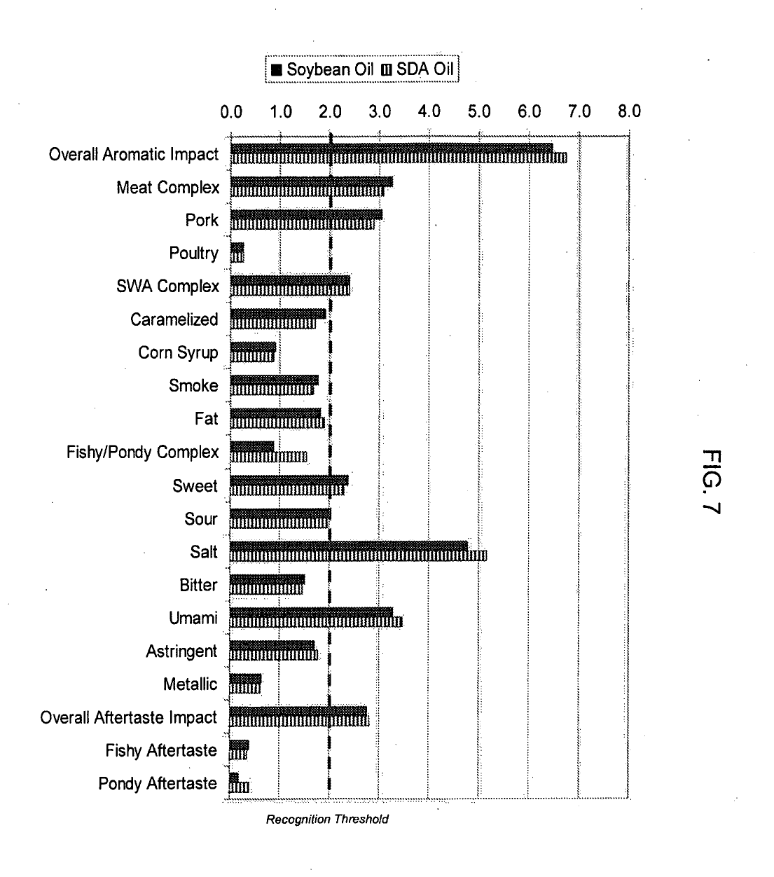

There were detectable differences between the soybean oil cooked ham and the SDA oil Cooked Ham, shown in Table 18. The soybean oil cooked ham was higher in pork aromatics (FIG. 7).

The SDA oil cooked ham was higher in overall flavor, fishy/pondy complex, and salt basic taste (FIG. 7).

The fishy/pondy aromatics and aftertaste in the soybean oil cooked ham and SDA oil cooked ham were below the recognition threshold (2.0), indicating consumers would not be able to detect these aromatics in the samples.

TABLE 18
Mean Scores for Flavor and Aftertaste Attributes of Cooked Ham

| | Soybean | | | |
|---|---|---|---|---|
| Aromatics | Oil | SDA Oil | HSD value | p value |
| Overall Aromatic Impact | 6.5 b | 6.7 a | 0.256 | ** |
| Meat Complex | 3.3 a | 3.1 a | 0.318 | NS |
| Pork | 3.1 a | 2.9 b | 0.142 | ** |
| Poultry | 0.3 a | 0.3 a | 0.264 | NS |
| SWA Complex | 2.4 a | 2.4 a | 0.210 | NS |
| Caramelized | 1.9 a | 1.7 a | 0.243 | * |
| Maple | 0.1 a | 0.3 a | 0.295 | NS |
| Corn Syrup | 0.9 a | 0.9 a | 0.135 | NS |
| Molasses | 0.0 | 0.0 | n/a | n/a |
| Other SWA | 0.0 | 0.0 | n/a | n/a |
| Smoke | 1.8 a | 1.7 a | 0.259 | NS |
| Fat | 1.8 a | 1.9 a | 0.227 | NS |
| Fishy/Pondy Complex | 0.9 b | 1.5 a | 0.541 | ** |
| Fishy | 0.4 a | 0.8 a | 0.452 | NS |
| Pondy | 0.4 a | 0.8 a | 0.432 | * |
| Metallic | 0.6 a | 0.6 a | 0.321 | NS |
| Cardboard/Woody | 0.6 | 0.6 | n/a | n/a |
| Painty | 0.0 | 0.0 | n/a | n/a |
| Basic Tastes & Feeling | | | | |
| Factors | | | | |
| Sweet | 2.4 a | 2.3 a | 0.283 | NS |
| Sour | 2.0 a | 2.0 a | 0.167 | NS |
| Salt | 4.8 b | 5.2 a | 0.346 | ** |
| Bitter | 1.5 a | 1.5 a | 0.117 | NS |
| Umami | 3.3 a | 3.5 a | 0.300 | NS |
| Astringent | 1.7 a | 1.8 a | 0.087 | NS |
| Metallic | 0.6 a | 0.6 a | 0.083 | NS |
| Burn | 0.2 a | 0.1 a | 0.110 | NS |
| Aftertaste | | | | |
| Overall Aftertaste Impact | 2.8 a | 2.8 a | 0.199 | NS |
| Fishy Aftertaste | 0.4 a | 0.3 a | 0.336 | NS |
| Pondy Aftertaste | 0.2 a | 0.4 a | 0.226 | * |

¹Means in the same row followed by the same letter are not significantly different at 95% Confidence.
***99% Confidence,
** 95% Confidence,
* 90% Confidence,
NS—Not Significant
The attributes above threshold are bold.
The attributes significant at 90% Confidence are italicized.
For other attributes, % score is the percentage of times the attribute was perceived, and the score is reported as an average value of the detectors.

### Example 9

### Example of SDA Oil Enhancement of Raw or Cooked Whole-Muscle Meat

A brine/marinade solution was prepared for enhancement of boneless, skinless, chicken breast halves via direct injection into the breast meat portions. Brine was prepared by combining formulation water, a water and ice mixture (15 parts ice to each 85 parts water) and alkaline phosphate and mixing utilizing high speed shear to dissolve the phosphate ingredient. An ADMIX Rotosolver mixer (Model XP)@, Admix, Inc., Manchester, N.H.) serves as and example of a high shear blending apparatus. Isolated soy protein ingredient (i.e., SUPRO® 248, SUPRO® 516 or SUPRO® 590 manufactured by Solae, LLC, Saint Louis Mo.) or functional soy protein concentrate ingredients (i.e., ALPHA® DS manufactured by Solae LLC, Saint Louis, Mo.) should be added to the brine solution only after the alkaline phosphate has been dissolved into the brine solution. Isolated soy protein or functional soy protein concentrate ingredients should be mixed for hydration for six to eight minutes prior to addition of other ingredients to the brine solution. Salt, if added, would be added to the brine only after dispersion and hydration of the soy ingredient material. The soy oil, SDA containing soy oil or any edible oil liquid at zero centigrade would emulsify into the soy protein containing brine solution. Total time duration required to properly prepare SDA oil containing brine should be 15 to 20 minutes. Brine solution provided in Table 19.

TABLE 19
Brine composition

| | | SBO | SDA |
|---|---|---|---|
| Brine composition | General | Control | Test |
| Meat Extension, % | 20.00 | 20.00 | 20.00 |
| Ingredients | % | % | % |
| Water | 92.20 | 89.20 | 89.20 |
| Isolated soy protein (i.e., | 6.00 | 6.00 | 6.00 |
| SUPRO ® 248) | | | |
| Alkaline phosphate | 1.80 | 1.80 | 1.80 |
| Soybean oil (SBO) | 0.00 | 3.00 | 0.00 |
| SDA enriched soybean oil | 0.00 | 0.00 | 3.00 |
| Total | 100.00 | 100.00 | 100.00 |

Boneless, skinless chicken breasts were used to provide an example of intact meat or whole-muscle injected meat application for SDA-containing soybean oil. Other raw meats such as boneless and bone-in pork loin chops, lamb bone-in rib chops and beef loin top loin steak could be augmented via injection.

A multiple-needle meat injector (Wolking-Belam MI 650-306 injector (CFS, Inc., Bakel, The Netherlands) would be utilized to enhance the raw chicken breast meat with a fluid containing SDA containing soybean oil. Such injectors would be equipped with 3-mm outside diameter or smaller needles for marinating or enhancing intact meat intended for cooking from raw by consumers or for manufacture of cooked meats such as precooked roasts and chops. Brine should be agitated during injection to ensure complete suspension of the brine ingredients. Multiple passes through the injector may be required to achieve the desired enhancement. Injected raw meat food composition is described in Table 20

TABLE 20
Raw extended meat content

| | | SBO | SDA |
|---|---|---|---|
| Raw extended meat content | General | Control | Test |
| Meat extension, % | 20.00 | 20.00 | 20.00 |
| Ingredients | % | % | % |
| Boneless chicken breast | 83.33 | 83.33 | 83.33 |
| Water | 15.37 | 14.87 | 14.87 |
| Isolated soy protein (i.e., | 1.00 | 1.00 | 1.00 |
| SUPRO ® 248) | | | |
| Alkaline phosphate | 0.30 | 0.30 | 0.30 |
| Soybean oil (SBO) | 0.00 | 0.50 | 0.00 |
| SDA enriched soybean oil | 0.00 | 0.00 | 0.50 |
| Total | 100.00 | 100.00 | 100.00 |

Intact raw meat may be extended with a solution enhanced with SDA containing oil using vacuum tumbling alone. Small meat chunks, cubes, muscles or muscle groups may be enhanced by tumbling under strong vacuum with an enhancing solution such as described in table 19. For 20 to 30 minutes. Most of the fluid uptake for vacuum tumble enhanced products would be located within the outer 3 mm of the meat pieces.

### Example 10

### Vegetarian Hotdog

TABLE 21
Vegetarian Hotdog Formulation

| | Control SBO | | Test SDA | |
|---|---|---|---|---|
| Ingredients | % | Kg | % | Kg |
| Water/ice | 61.05 | 61.05 | 61.05 | 61.05 |
| ALPHA ® 5800 | 17.00 | 17.00 | 17.00 | 17.00 |
| Vital wheat gluten | 7.00 | 7.00 | 7.00 | 7.00 |
| Soybean oil (SBO) | 5.00 | 5.00 | 0.00 | 0.00 |
| SDA enriched soybean oil | 0.00 | 0.00 | 5.00 | 5.00 |
| Modified food starch | 3.00 | 3.00 | 3.00 | 3.00 |
| Dextrose | 2.00 | 2.00 | 2.00 | 2.00 |
| Methylcellulose | 1.50 | 1.50 | 1.50 | 1.50 |
| Frankfurter spice | 1.50 | 1.50 | 1.50 | 1.50 |
| Beef flavor | 1.25 | 1.25 | 1.25 | 1.25 |
| Salt | 0.50 | 0.50 | 0.50 | 0.50 |
| Garlic powder | 0.20 | 0.20 | 0.20 | 0.20 |
| Total | 100.00 | 100.00 | 100.00 | 100.00 |

### Vegetarian Frankfurter Preparation Procedure

All formulation water (50/50 combination of water and ice) is placed in the bowl chopper (Kramer Grebe Type Chopper, Model VSM 65, Biedenkopf, Germany), over the methylcellulose ingredient. The water and methylcellulose combination is chopped initially using lowest knife or cutter-head speed until the methylcellulose was dispersed into the water. The cutter speed is increased to maximum speed and the mixture chopped for 3 to 5 minutes. The vital wheat gluten is mixed into the water and methylcellulose mixture utilizing a low knife speed; however, once the gluten is mixed in the bowl chopper mixture the gluten is textured by chopping the mixture at maximum knife speed for 2-4 minutes. The ALPHA® 5800, soy protein concentrate (Solae, LLC), is added using low cutter-head speed to prevent dusting and once the soy protein concentrate is dispersed and hydrated the bowl chopper contents are chopped 2-3 minutes. The soybean oil or SDA enhanced soybean oil are distributed throughout the bowl chopper contents using low speed until dispersed throughout water, methylcellulose, soy protein concentrate and wheat gluten mixture; this is done to minimize or prevent splashing of the vegetable oil; once the oil is dispersed the food ingredients mixture is chopped to emulsify the oil using maximum cutter head speed. Remaining dry ingredients are added to the chopper bowl and the ingredients chopped into the food ingredients mixture using maximum cutter-head speed. Once all ingredients have been combined and dispersed into a homogenous mixture the combined ingredients are chopped using maximum knife/cutter-head speed while under vacuum for 3-4 minutes. Vacuum achieved is equivalent to 25 inches of mercury. The food mixture is stuffed into size 24 cellulose casings using a Handtmann VF 200 filler (Handtmann, Buffalo Grove, Ill.) and cooked until internal temperature of 190-195° F. (88-90° C.) utilizing an Alkar thermal processing unit (Alkar-RapidPac, Inc., Lodi, Wis.). The thermal processing schedule that can be used to smoke and cook the vegetarian frankfurters is described in Table 22. Cooked product is chilled to an internal temperature 2° C. in preparation for casing removal. Cellulose casings are removed and vegetarian links are refrigerated at less than 4° C. after vacuum packaging in oxygen barrier film or the vegetarian hotdog can be stored frozen after packaging.

TABLE 22
Cooking conditions and thermal process

| | | | Internal | Dry Bulb | Wet Bulb | Cooking Chamber |
|---|---|---|---|---|---|---|
| | Cook Step | | Temperature | Temperature | Temperature | Relative |
| Cook Step | Type | Time, (min.) | (° C.) | (° C.) | (° C.) | Humidity (%) |
| 1 | Cook | 8 | — | 74 | 56 | 40 |
| 2 | Cook | 10 | — | 82 | 71 | 60 |
| 3 | Cook | 10 | — | 88 | 82 | 80 |
| 4 | Steam Cook | To | 88-90 | 100 | 100 | 100 |
| | | Temperature | | | | |

### Example 11

### Formulation and Method for a Preparation of a Simulated Meat Product

A formulation for the manufacture for a simulated meat product is provided in Table 23. The example describes means for creating a simulated meat product using finely ground meat or meat paste and a structured or textured vegetable ingredient (SUPRO® MAX 5050, Solae, LLC). A vegetarian simulated meat product could be created using a structured vegetable protein ingredient and a binder such as dried egg white, isolated soy protein, methylcellulose, etc.

TABLE 23

| | Control | SDA Test |
|---|---|---|
| Ingredient | Content, % | Content, % |
| SUPRO ® MAX 5050 | 13.00 | 13.00 |
| Hydration water | 47.60 | 47.60 |
| Caramel color | 0.28 | 0.28 |
| Lactic acid (88% solution) | 0.33 | 0.33 |
| Mechanically separated chicken | 27.00 | 27.00 |
| (15%-20% fat) | | |
| Salt | 1.04 | 1.04 |
| Cure salt | 0.13 | 0.13 |
| SDA enriched soybean oil | 0.00 | 3.50 |
| Soybean oil | 3.50 | 0.00 |
| Alkaline phosphate | 0.30 | 0.30 |
| SUPRO ® EX 33 | 6.00 | 6.00 |
| Sodium acid pyrophosphate | 0.20 | 0.20 |
| Beef flavor | 0.62 | 0.62 |
| Total | 100.00 | 100.00 |

### Simulated Meat Food Preparation

Formulation water (50° C.), caramel coloring and SUPRO® MAX 5050, structured vegetable protein ingredient are combined in a paddle blender capable of blending contents under continuous vacuum. The blender is held under vacuum for 10 minutes prior to starting the blender arms. The structured vegetable protein ingredient is shredded via blending; typical blending duration is 45 to 60 minutes. The meat ingredients and alkaline phosphate are added to the hydrated and shredded structured vegetable protein ingredient and blended an additional 1 minute. Salt and cure salt are added and the mixture blended for 10 minutes. Following blending of the meat and structured vegetable protein ingredient the lactic acid is added and the mixture blended an additional 1 minute. Following incorporation of the lactic acid, all remaining formulation ingredients are blended into the meat mixture by blending an additional 15 minutes. The blended meat mixture is transferred to a Handtmann filler (Handtmann, Buffalo Grove, Ill.) equipped with a modified stuffing horn. The stuffing horn is modified to form a sheet of extrudate roughly 9.5 mm thick by 5 cm wide and any length. The formed meat and structured vegetable protein mixture is par-fried in soybean or canola oil for 45 seconds at 160° C. (320° F.). The par-fried substrate is cooked to an internal temperature of 85° C. using an Alkar thermal processing unit (Alkar-RapidPac, Inc., Lodi, Wis.) set at 100° C. maintained with 80% relatively humidity within the cooking chamber. Cooked simulated meat product was cooled to 4° C. The simulated meat food can be consumed as manufactured or processed further into meat shreds, strands or cubes utilizing commercial cutting and sizing equipment.

While the invention has been explained in relation to exemplary embodiments, it is to be understood that various modifications thereof will become apparent to those skilled in the art upon reading the description. Therefore it is to be understood that the invention disclosed herein is intended to cover such modification as fall within the scope of the appended claims.

What is claimed is:

1. A meat composition having a quantity of omega-3 fatty acids, wherein the composition comprises:
a. a quantity of a stearidonic acid; and,
b. a meat.

2. The composition of claim 1, wherein the composition further includes at least one stabilizing agent.

3. The compositions of claim 1, wherein the meat is selected from the group consisting of processed meat compositions, whole muscle meat compositions, coarse-ground meat compositions, semidry meat compositions, dry meat compositions, canned meat compositions, smoke meat compositions, dehydrated meat compositions, raw meat compositions, cooked meat compositions, emulsified meat compositions, simulated meat compositions, meat analog compositions, and combinations thereof.

4. The composition of claim 1, wherein the stearidonic acid is stearidonic acid enriched soybean oil.

5. The composition of claim 2, wherein the at least one stabilizing agent is a phospholipid or combination of phospholipids.

6. The composition of claim 5, wherein the phospholipid ranges between about 0.01% to about 65% by weight of the stearidonic acid.

7. The compositions of claim 1 wherein the composition further comprises a secondary antioxidant.

8. A method of using stearidonic acid enriched soybean oil to form a meat composition, wherein the method comprises:
a. adding stearidonic acid enriched soybean oil to a meat composition; and,
b. processing the meat composition.

9. The method of claim 8 wherein the stearidonic acid enriched soybean oil comprises between about 5% and about 100% of fat required in the meat composition.

10. The method of claim 8 wherein at least one stabilizing agent is added to the meat composition

11. The compositions of claim 1, wherein the sensory characteristics of the meat composition containing the stearidonic acid are comparable to the sensory characteristics of meat compositions that do not contain stearidonic acid.

12. The method of claim 8 wherein the sensory characteristics of the meat composition made from the method are comparable to the sensory characteristics of meat compositions that do not contain stearidonic acid.
